(19) United States
(12) Patent Application Publication
(10) Pub. No.: US 2004/0039603 A1
(43) Pub. Date: Feb. 26, 2004

(54) Method and system for acquiring healthcare professionals for domestic service

(76) Inventor: Lawrence M. Hanrahan, Houston, TX (US)

Correspondence Address: JONES DAY, P.O. BOX 660623, DALLAS, TX, 75266-0623, US

(21) Appl. No.: 10/602,390

(22) Filed: Jun. 23, 2003

Related U.S. Application Data
(60) Provisional application No. 60/390,574, filed on Jun. 21, 2002.

(51) Int. Cl. G06F 17/60

(52) U.S. Cl. 705/2

(57) ABSTRACT

The present invention is directed to a system, method and software program product for placing foreign professionals in the United States for employment. The present placement process is an integration of a plurality of tightly-coupled placement sub-processes which are controlled and managed by a single placement service provider entity, while the individual placement sub-processes and minor sub-processes are accomplished by third-party service providers. Subparts of the present placement process are not performed as a series of discrete sub-processes or in a strict sequential order, but are initiated by the occurrence of an event which may be the occurrence of an internal event within a previous subpart or the completion of a prior subpart. Candidates are accepted into the placement process by the placement service provider rather than by an employer and the placement service provider assumes the risk for physically placing candidates at an employer's location at a specified date. A candidate placement and tracking application monitors candidates' progress and constantly compares the candidates' measured progress with a predetermined standard. The application assesses candidate performance and identifies weak candidates who can be proactively encouraged to improve early in the process. Additionally, the number of candidates in the placement pool is maintained at a predetermined number by the placement and tracking application, and candidates are categorized on the basis of their progress in the placement process, not on the basis of whether or not the candidate has accepted an offer of employment. Thus, candidates may be available at any stage in the placement process for recruiting. Therefore, candidates who drop out of the process are more readily replaced with candidates who have progressed to a similar stage in the process and the pre-specified placement date can be met.

### CROSS REFERENCES TO RELATED APPLICATIONS

The present application is related to and claims priority from co-pending U.S. provisional patent application entitled “Method and System for Acquiring Healthcare Professionals for Domestic Service” having application No. 60/390,574 filed on Jun. 21, 2002, currently pending. The above-identified applications are incorporated by reference herein in their entirety.

### BACKGROUND OF THE INVENTION

1. Field of the Invention

The present invention relates to a system, method and software program product for placing foreign professionals in the United States for employment. More particularly, the present invention relates to a system, method and software program product for a placement process which is an integration of a plurality of tightly-coupled placement sub-processes which are controlled and managed by a single placement provider entity, including the individual placement sub-processes and minor sub-processes, which may be provided by integrated in-house sub-parts of the placement provider or by independent third-party service providers.

2. Description of Related Art

In recent years the United States and other industrialized countries have experienced a shortage of educated and trained professionals. Shortages normally occur in an industry for two fundamental reasons: a decrease in qualified candidates and/or an increase in the number of positions to be filled. Poor pay, working conditions, lack of educational opportunity, an aging workforce, low unemployment in comparable career fields and cyclical employment are all factors which may also contribute to shortages, either singularly or in combination with one another. Increasing demand for trained professionals often results from periods of economic expansion in general, the growth of a specific industry, as well as fundamental shifts in the nature of a profession or the role of professions in an industry. Regardless of the causes, shortages of the professionals must be addressed for the near term and the long term. However, the near term solutions are often particularly difficult to resolve.

With regard to healthcare professionals in general, and Registered Nurses (RNs) in particular, the number of skilled professionals are shrinking relative to the general population, while at the same time the need for those professionals is increasing. The nursing shortage in the United States is largely a result of the overall aging of the general population, inadequate U.S. demographics in the 17-22 years olds, and of nurse professionals in particular and is exacerbated by a fundamental shift in how healthcare is delivered in the United States (i.e., less reliance on medical doctors and more on nurse professionals). In the next ten to fifteen years, as much as forty-percent of the current nurse professionals who are eligible for retirement will reach retirement age, while the corresponding baby boomers' health needs will spark increasing demands for nurses. Estimates vary widely between reliable sources, but current estimates maintain that the United States has approximately 500,000 more positions for nurse professionals than for nurses and over the next ten years that deficit is expected to grow to over 1,000,000 and reach a million is less than ten years. While this projected shortage may mean bright job prospects for future nursing graduates, this shortage will affect not only the health care of this aging generation, but of all those who seek healthcare services.

Long-term fixes for the nation's shortage of nurse professionals include increasing the availability and funding of loans, stipends and scholarship programs, providing tax incentives for employers and funding more research for data collection efforts, modeling the nurse professional workforce, partnerships between communities and states aimed at recruitment and retention programs and assessing the impact of nursing practices on patient wellbeing. Additionally, recruiting and retaining non-traditional nurse professionals increases the pool of prospective candidates from which to draw. Non-traditional nursing categories include males, minorities and aliens. Acceptance of some or all of these proposals will increase the future supply of nurse professionals in the pipeline but have relatively little effect on the immediate need for nurses.

Some jurisdictions have taken specific actions to identify the causes of the shortage and provide solutions. Below is a summary of the actions adopted by one country, the Irish Department of Health and Children, for addressing the domestic nursing shortage:

allowances for specialist qualifications;

standardized overtime working arrangements;

greater flexibility in rostering;

part-time work;

significant improvement in the promotional structure;

introduction of a clinical career pathway;

increased number of student places;

provision of Return-to-Practice courses;

expansion in the number of post-registration courses in specialized areas of clinical practice;

international recruitment of registered nurses;

payment of fees for registered nurses wishing to undertake nursing and certain other undergraduate degree courses on a part-time basis linked to a service commitment;

revised sponsorship arrangements for student public health nurses and midwives linked to service commitment; and

launching of an anti-bullying strategy.

Short-term solutions are more problematic because they generally require an available but untapped resource for experienced nurse professionals from which to recruit. Thus, three possible categories of experienced nurses exist: retired, inactive and alien. Of the three categories, the most abundant source for experienced nurse professionals is internationally and therefore a need exists for healthcare institutions in the United States to attract experienced professionals from foreign countries.

International recruitment of foreign professionals for placement in the United States is a complicated, expensive and risky undertaking for an enterprise. The level of complexity is proportional to its cost and risk, and inversely proportional to the likelihood of a successful outcome. Some aspects of placing foreign professionals may not substantially differ from one profession to another, while the complexity of other aspects may vary dramatically between professions. Moreover, the process itself may differ greatly between candidates in the same profession. For example, learning English is equally difficult for an engineer or a nurse professional from the same country, so learning the language is relatively consistent between different types of professionals from the same country. However, as a practical matter, individuals enter the placement process with different levels of familiarity with the English language, even within a profession. Thus, some individuals may need supplemental preparatory work prior to sitting for an English proficiency examination. Additionally, certain professionals are required to sit for professional proficiency examinations while other types of professionals are not. For example, a nurse professional is required to take and pass a battery of professional proficiency tests, whereas no equivalent testing is required for an engineer from the same country. Generally, the more regulated the profession in the United States, the more complex the placement process becomes for foreign professionals.

The prior art accomplishes the placement process in discrete sub-processes which are performed sequentially, to one degree or another, for every profession. Before describing the sub-processes, a distinction should be drawn between placement of foreign professionals in the United States and the placement of foreign professionals with a U.S. employer. In placing professionals in the United States, the paramount condition to be met is the satisfactory completion of an interview with the U.S. embassy (the interview requirements will be discussed below, but by and large the U.S. embassy interview is the culminating and verification event of all sub-processes for placement in the U.S.). Placing foreign professionals with an employer located in the U.S. is a somewhat difficult process then merely immigrating to the U.S. In order to work for an U.S. employer, the foreign professional may be required meet other requirement that are not imposed for immigration. Often other governing bodies impose additional prerequisites for obtaining a work license, which must be met prior to the foreign professional being sanctioned for work by the governing body. These governing authorities include national, state, local governments, as well as quasi-government professional accreditation and licensure organizations.

The placement sub-processes are depicted in FIG. 1 in the sequence in which they are performed in accordance with the prior art. Also depicted in FIG. 1 are the maximum and minimum processing times expected for placing professionals in the United States from a non-English speaking foreign country, wherein the processing times relate to healthcare professionals, specifically nursing professionals. Here it should be understood that while FIG. 1 depicts the prior art placement process as the discrete sub-steps of Recruiting, Examining, Bureau of Citizenship and Immigration Services (BCIS) processing (formerly known as the Immigration and Naturalization Service (INS), now a bureau of the Department of Homeland Security (DHS)), U.S. Embassy Processing, U.S. Placement and State Licensure, in practice each sub-processes is a compilation of related tasks (or lower-level sub-processes) that must be performed.

The prior art placement process begins with recruiting procedures, wherein a prospective employer evaluates foreign professionals as potential candidates for a position (step 102). An ideal preliminary candidate should have a high academic ranking from an accredited learning institution known for excellence in the occupational area, have a minimum experience level in a pertinent field and have a good mix of experience in related fields, be proficient (or nearly proficient) in written and spoken English, be healthy, have a good moral character as assessed by both the DHS and the employer and not have ties to any group that may pose a terrorist threat to the U.S. or its allies. In all but the most exceptional cases, recruiting potential candidates is performed in the candidate's resident country. Thus, the employer's recruiter must travel to the resident country of the applicant-candidates. It may be necessary for the recruiter to make several recruiting trips depending upon the employer's needs, the availability of potential candidates and other scheduling concerns. Once suitable preliminary candidates have been identified through the recruiting process, it is expected that each preliminary candidate who accepts an offer of employment will be required to demonstrate proficiency in at least two separate areas: in their respective professions; and in the use of the English language. This may be accomplished through the administration of skills proficiency testing for the candidate's respective profession and for English as a foreign language (step 104). It might also be necessary for a candidate to undertake a curriculum of preparatory courses in order to sit for the professional proficiency examinations. The extent of preparatory work may vary from one candidate to another. A corollary to the proficiency requirement is the necessity that a candidate speak, write and understand English prior to taking the professional proficiency tests. Therefore, prior to registering for either the professional proficiency coursework or examinations, it is necessary for candidates to pass one or more English proficiency examinations as well. Here again, preparatory work may be required prior to sitting for the English proficiency exam, the length of which may also vary from one candidate to another. Additionally, sitting for most professional proficiency examinations further requires meeting certain eligibility requirements by way of a credentials' review. Eligibility generally turns on the foreign professional's education, practice and licensure meeting registration requirements approximately equivalent to those set for professionals licensed domestically in that field. The applicant's filing documentation is scrutinized, as well as other professional credentials such as education transcripts, learning institution accreditation, the educational program of theoretical instruction and practical practice and professional license(s).

Demonstrating a minimum level of proficiency is typically a prerequisite for continuing the placement process and essential for meeting the U.S. Embassy interview requirements under the Department of Labor (DOL) schedule of occupations for which the individual permanent labor certification procedure is not required. Moreover, the standardized testing regime may be the only objective metric for an employer to gauge a particular candidate's capabilities. The inability of a candidate to pass the required tests in a reasonable time period is a major factor in candidates dropping out of the placement process. However, the employer may set artificially high benchmarks for a candidate to attain in order to continue with the placement process and thereby actually increase the candidate placement process attrition or increase the placement time.

Only when a candidate has successfully passed the required tests does he or she begin the Bureau of Citizenship and Immigration Services (BCIS) review procedures (formerly the Immigration and Naturalization Service (INS)) review (step 106). Many of the preliminary steps for obtaining a visa are initiated by the employer; however, employers are often reluctant to initiate the process without the subject candidate establishing competency to continue with the placement process. Typically, the BCIS process commences with the filing of a request (usually a petition) for permanent residency by the employer in which the employer attests that the candidate has been offered employment in an occupation not requiring the permanent labor certification procedure by the DOL. The BCIS filing also establishes a priority date for issuing a visa number once the applicant has been approved for a visa. As the BCIS screening process continues, it becomes more necessary for the candidate to be involved.

The ultimate objective is for the candidate to obtain a visa for entry into the United States. However, certain factors work against the candidate wishing to immigrate to the U.S. Only a predetermined quantity of visas are authorized each year by the U.S. State Department, and that amount is based on a maximum number of immigrants authorized to enter the United States from each foreign country. A predetermined portion of the predetermined quantity is processed by each of the four BCIS regional offices in the United States (i.e., the north, south, east and west). These three factors further complicate the placement process by limiting the total number of visas authorized, setting a maximum for each country of origin and adding a regional processing visa component to the BCIS review procedure (the regional processing aspect of the visa grant process will be described in greater specificity below with regard to FIG. 2. Additional factors may also add complexity to the BCIS procedure such as the type of visa being sought, availability of the alien, the alien's nationality, and the completeness of the alien's personal records and transcripts. Once approved for a visa, the candidate's acceptance is acknowledged by the BCIS and the candidate awaits his(her) turn for proceeding to the U.S. Embassy processing. Once the priority date is current (a visa is immediately available to the candidate), a set of forms is sent to the applicant (known as a Packet 3).

After the visa number is current, and the Packet 3 forms have been completed, the candidate presents the visa number and the completed forms to the consulate and begin U.S. embassy processing (step 108). A U.S. embassy in the candidate's resident country must perform a subsequent screening of all potential immigrants attempting to enter the United States and physically issue a visa to a candidate. The purpose of the embassy screen is to verify that the processing has been completed and that all requirements for entry into the United States have been met by the immigrant. Essentially, this screening amounts to verifying that all of the documentation specified by the Packet 3 is correct, current, authentic and certified. The Embassy has the sole responsibility for verifying certain requirements including corroborating pre-entry drug and criminal background checks, obtaining a pre-departure medical exam clearance and verifying passport authenticity and information. Since the time required for BCIS processing may be excessive, the U.S. consulate may require updated documentation from a candidate. Only then will a visa be issued and the candidate be allowed to travel to the United States.

The final discrete sub-process in the placement process is the physical relocation and adjustment of the foreign professional in the new location, i.e., the assimilation (step 110). A major factor contributing to foreign professionals returning to their home countries prior to completing their employment commitment is related to difficulties in assimilating into the local community. Therefore, the initial physical placement might be the most important factor for an employer to consider in the placement process. In the U.S., it has been estimated that the foreign professionals who successfully assimilate into their employer's community remain with that employer at least twice as long as other professionals in the same field. Adequate physical procedures increase the likelihood that a foreign professional will successfully assimilate into the local community, which in turn virtually guarantees the employer of an extended tenure from the foreign professional employee. Extending the employment tenure of foreign professionals is important for two reasons. First, extending employment service increases the basis to which the initial premium for acquiring the foreign professional may be applied. Thus, the premium cost for placing the employee decreases when measured on a per unit hour charge. More importantly, however, is longevity which reduces the occurrence of one-time charges regularly associated with all hiring. Therefore, while the goal of placing foreign professionals may be considered a short-term solution for employment shortfalls, the benefit to the employer may be long term as the frequency of occurrence for one-time charges associated with all hiring is lowered.

However, prior art placement processes have overwhelmingly failed to take into account these factors when placing a foreign professional. To make matters even worse, this is the point in the placement process where control is generally shifted employer from the placement service provider (if used) to the employer and the newly placed candidate must establish a new set of relationships with an entirely different group of people. Even more problematic for all concerned is meeting the professional requirements for working as a professional set out by any national, state, and local governments, and/or professional accreditation and licensure organizations (step 111). In a worse case scenario, the situation may arise where an employer sponsors a candidate for immigrating to the U.S. who meets the requirements for immigration, then fails to attain the necessary license(s) for working in the profession in which the candidate was originally hired. The result is that the employer must restart the placement process with another foreign professional, ad even worse, (depending on the terms of the contract with the placement serviced provider if one is used), the fees and cost for placing the candidate may be lost. The prior art placement process will be described in greater detail below with respect to FIGS. 3A-3F.

FIG. 2 is a logical diagram for the prior art placement process for a specific type of foreign professionals, nursing professionals, which depicts the processing time necessary to complete each subpart of the placement process based on a candidate's group type (a group type, which will be described below, essentially identifies where the candidate is in the placement process relative to other candidates). FIG. 2 depicts the interaction between the complexity of various parts of the prior art placement process and the total placement processing time. Placement processing time, for the purpose of describing the present invention, is measured not only as the time period after a preliminary candidate is accepted into the prior art placement process by receiving and accepting an offer from an employer, but also includes the time required to identify and induce applicant-candidates to participate in the recruiting event. FIG. 2 particularly points out the relationship between the employment location and the progress of the candidate in the test sub-part to the total placement time.

Note from the chart that the placement process is divided into process subparts (i.e., recruiting, testing, BCIS processing, embassy processing, assimilation or physical placement, and domestic licensure). It is expected that each subpart would require a finite amount of time for candidates identified with any group type to complete except testing 204 (based on the group type) and BCIS processing 206. With regard to testing 204, the expected processing time for a candidate to successfully complete the testing requirement depends upon the candidate's grouping type 220 (i.e., from P1 to P5). Notice that as a candidate's group type 220 traverses from P5 to P1, a corresponding reduction in the amount of time from 78 weeks to 39 weeks in testing 204 is likewise realized. The processing time depends upon the candidate's readiness to test, the extent of preparatory work necessary for readiness, the availability of a testing date, and the availability of funds for implementing the placement process. Clearly, it can be expected that the extent of preparatory work will vary from one candidate to another depending upon a particular candidate's readiness to test. A more detailed description of group type identifiers is presented below with respect to the descriptions of FIG. 4 and corresponding Table II below.

The effects of the complexities of regional BCIS processing on the prior art placement process are diagrammatically illustrated in FIG. 2 whereby the expected time period for a candidate to complete BCIS processing 206 depends largely upon which BCIS regional office processes the candidate's visa application, and, as mentioned above, the BCIS regional office that processes a candidate's application depends upon the geographic location of the employer for the candidate. The expected time for BCIS processing 206 varies from as little as twelve weeks when the employer is physically located in the northern United States, with the northern BCIS division 206N performing the processing, to as long as forty-three weeks when the employer is physically located in the eastern United States, with the eastern BCIS division 206E performing the processing. The expected time for BCIS processing 206 of a candidate takes fourteen weeks in the western United States and forty weeks in the southern United States where the southern BCIS division 206S handles the candidate's visa application. Of course, employers may actually have several physical locations that are geographically dispersed across the United States and in those situations, the placement location would dictate which BCIS division would perform the processing.

U.S. Embassy processing 208, Assimilation 210 and Domestic Licensure 211 are depicted as being constant throughout all group types as twelve, four and eight weeks respectively, but in reality the length of each of these time periods will vary depending on factors not related to pre-licensing testing and BCIS processing. From the diagram, it can be inferred that completion of the prior art placement process would be expected to take between 83 weeks (over a year and seven months) and 153 (nearly three full years (156 weeks)). Analyzed by region, employers in the northern region should expect the placement time period to take between 83 and 122 weeks because BCIS northern region 206N processing is relatively short at only 12 weeks. Alternatively, employers that are geographically situated in the eastern region should expect the placement time period to take between 114 and 153 weeks due to, among other factors, the higher number of immigrants processed by BCIS eastern region 206E, 43 weeks. Significantly, rarely would an employer expect to come across a candidate who has completed any of testing 204 and therefore could never expect to recruit from any candidate group except the least tested candidates in group P5.

Calculating the total placement costs to an employer is a complicated undertaking. With regard to traditional economics, total costs are defined as the sum of fixed and variable costs (i.e., fixed costs being the part of the budget that stays the same regardless of production quantity and variable costs being the rest of the total costs that varies, though not necessarily proportionally, with production level). However, for clarity in describing the present intention, total placement costs to an employer are defined herein as the sum of the employer's “direct” and “indirect” expenses resulting from inefficiencies in the placement process. Virtually every cost associated with placement is a variable cost since it is expected that the employer is not in the business of hiring employees, but instead an employer hires employees to provide a service (e.g., healthcare services). Thus, the classification into fixed and variable has little meaning with regard to a discussion of costs associated with a placement process.

Direct costs refer to an employer's out-of-pocket expenses for placement. Calculating the direct costs for placing employees is usually a straightforward calculation based on the cost of resources expended in the placement process. With regard to the placement of foreign nursing professionals, as will be discussed in great specificity below, examples of direct costs include: fees for various service providers (e.g., attorneys, foreign placement professionals, preparatory course providers, etc.; government fees (e.g., visa application filing, state licensure,); quasi-government fees (e.g., Commission on Graduates of Foreign Nursing Schools (CGFNS); National Council Licensure Examination (NCLEX); Test Of English as a Foreign Language (TOEFL); Test of Written English (TWE); Test of Spoken English (TSE); and ICHP (International Commission on Healthcare Professionals); “Visa Screen” certificate, etc.; hourly wages for time expended by in-house Human Resources department (HR) staff members attributable to placement, advertising, travel, etc. While direct costs to an employer would seem to be readily discernible and therefore more straightforward to calculate, such is not always the case. For instance, turn-key contracts with service providers often result in additional costs to the employer which were not part of the original agreement. Even though the additional costs are direct, they are usually unexpected given the nature of a turn-key arrangement and are not included in initial placement cost estimates.

Indirect costs are all determents to the employer's financial statement that are not direct (i.e., total costs less direct costs). Indirect placement costs are extremely difficult for an employer to calculate and are problematical to reconcile as a quantifiable cost. In addition, a bias often exists in an enterprise against conceding indirect costs to the placement process. Again, with regard to the placement of foreign nursing professionals, examples of indirect costs include: premium costs for existing employees (e.g., overtime, bonuses, etc.); meeting staffing requirements during placement; premium costs for non-employees (e.g., temporary employees, travelers, and even candidate employees placed through a traveler arrangement (discussed below with regard to modified traveler agencies)) to meet staffing requirements during placement; diminishing return costs to the enterprise for expanding services using variable cost resources (e.g., lost productivity of employees resulting from expanding the placement process, lost productivity of Human Resources (HR) staff members resulting from expanding the recruitment of foreign candidates, etc.); increased direct and indirect costs due to candidate attrition in the placement process; and capital costs necessary for funding the total cost of the placement process. In addition to the costs described above, the indirect costs to an employer also include those lost opportunities based on the “time is money” paradigm. Lost opportunity costs are almost never charged to a placement process even though the process itself may be responsible for at least a portion of the opportunity costs. As may be apparent to one of ordinary skill in the art, most indirect costs may be properly considered variable costs. It may be readily recognized that indirect costs will increase with the number of candidates in the placement process. However, what may not be apparent is that indirect costs also increase with the duration of the placement process. As a general rule, indirect placement costs to an employer for placing foreign professionals are much higher than direct placement costs. However, the indirect placement costs are often not recognized by the enterprise as being attributable to the placement process.

Placing foreign professionals in an enterprise is an expense incurred by an employer due to a shortage of enterprise employees that would be ideally filled by domestically recruited candidates. However, because candidate employees are not available locally, the placement of foreign professionals is necessary. So long as employee shortages occur and the pool of domestic candidates is not sufficient to alleviate the shortage, it will be necessary to place foreign professionals in the enterprise. However, what is sought is a mechanism for efficiently implementing a placement process in an enterprise (i.e., a mechanism which will bring the total costs incurred for placing foreign professionals as close as possible to that for placing domestic professionals in the enterprise). The inefficiencies of the placement process can be better understood by examining their impact on a particular enterprise. Below is a discussion of the costs associated with implementing a placement process, such as those described in FIG. 1, for placing foreign healthcare professionals, specifically nursing professionals, in a hospital or Health Care Institution (HCI).

Most HCIs have an internal or in-house HR capable of efficiently staffing the HCI with domestic nursing professionals. It is therefore tempting for an HCI to undertake the placement of foreign professionals internally and thereby assume the entire risk for successfully placing candidate nursing professionals in open positions. This endeavor is expensive, time consuming and risky for the HCI because placing foreign nursing professionals is a non-traditional HCI service (i.e., a non-healthcare service), but is readily justified based on successes in placing domestic nursing professionals, an equally non-traditional HCI service. The direct costs to the HCI include each of those mentioned above, less those for outside service providers. The caveat is, of course, that the HCI's HR has the internal resources to provide all necessary placement services internally. These resources include having foreign placement professionals foreign counsel, preparatory course instructors, and in-house counsel competent with BCIS matters to mention a few. However, it is doubtful that many HCIs have the necessary resources to provide all of these placement services. It then becomes a matter of what parts of the placement process the HCI can perform efficiently, and what type of external service provider(s) to procure for handling the other parts of the placement process. Therefore, it can be rightly assumed that in most cases the HCI will incur direct costs for external service providers, in addition to government fees, quasi-government fees, HR staff time, advertising and travel.

The HCI will incur indirect costs for placing nursing professionals which are also identified above. Recall that indirect costs are similar to variable costs in that the cost per nurse increases with the duration of the placement process. The duration of the placement process (i.e., the time period for actually placing a nurse) can be a measure of the inefficiencies in a placement process, thus indirect costs can be used as a metric for measuring the efficiency of a placement process. Consequently, it can be expected that the indirect costs per nurse will increase with the HR's lack of sophistication with the placement process for foreign nurses, as it is less efficient. Furthermore, even if the HR is relatively sophisticated with the foreign placement process, the HR's ability to place native candidates may be impacted because of its resources being reallocated to hiring foreign professionals. As a result, placement costs for domestic candidates may be higher in an HR with a bifurcated placement process for managing both domestic and foreign nursing professionals, as might be predicted by the economic Law of Variable Proportions.

While the direct costs associated with placing nursing professionals may be readily identifiable, accurately calculating the indirect placement are problematic as discussed above. Furthermore, as alluded to above, certain indirect costs are not generally recognized as placement costs, or if they are, the costs are not recognized as resulting from the ineffectiveness of the process. This rationale occurs as a direct result of how costs for domestic placements were characterized. For example, traditionally placing a nursing professional merely entailed finding a well-suited, qualified domestic nursing candidate and hiring her or him. The process generally moved quickly and on the occasion where it did not, the delay was normally blamed on inadequacies in the candidate pool and not on inefficiencies in the placement process. Therefore, any indirect costs resulting from the position remaining open were also blamed on market conditions and not on the placement process. These assumptions were carried over to foreign placement and similarly to the domestic placement process. Additional indirect costs resulting from an extended placement period are routinely blamed on factors other than inefficiencies in the placement process. Thus, it has been difficult for HCIs to calculate the actual total placement costs of foreign professionals because much of the indirect costs are not recognized. Therefore, inefficiencies in the foreign placement process have not been fully recognized as such.

Historically, while the placement of domestic nursing professionals has been accomplished internally, within an HCI's HR, it has become apparent that the HR is not always well suited or staffed to handle the placement of foreign nursing professionals. Therefore, HCIs have actively collaborated with external placement service providers for finding, processing, and/or placing foreign nursing professionals. Typically, these external foreign placement services include: organizing agents (agent); Modified Travel Agencies (MTA); and Foreign Labor Search firms (FLS). The advantages of each will be discussed below with regard to the total costs to a typical HCI.

A foreign recruitment coordinator or organizing agent for foreign recruiting allows an HCI to defer some expenses related to finding and hiring foreign nursing professionals. An organizing agent may provide various other services in addition to recruiting; however, normally the agent's duties are narrowly directed to recruiting functions (i.e., get in, get the check and get out immediately). Ideally, a foreign recruiting agent will have some expertise in a particular country and possess a sufficient understanding of the recruiting process therein. This expertise translates into the identification of a greater number of preliminary candidates for the HCI's consideration. Ideally, the agent will identify higher quality candidates than the HCI could if it undertook the recruiting internally. Additionally, hiring an organizing agent actually reduces some up front expenses by limiting or even eliminating travel to that country associated with recruiting, although typically a HCI representative must travel to the candidate's country of residency for an interview.

Although an agent may provide the HCI with more preliminary candidates, those candidates do not necessarily translate into acceptable candidates because the HCI either did not make an offer or the offer was not accepted. Another problem with agent-recruited candidates is that the attrition rate is extraordinarily high, much higher than expected for HCI-recruited candidates during the placement process. Candidate attrition raises both the direct and indirect costs to the HCI. Some direct costs will reoccur for the replacement candidate, and because a replacement must be recruited in the first place, the length of the placement process is prolonged on a per-candidate basis. Additionally, the risk of candidates dropping out of the process is borne entirely by the HCI and is of little consequence to the agent.

Typically, an organizing agent contracts for a predetermined fee per accepted candidate. However, almost as a matter of course, the HCI incurs hidden fees and costs that were not initially disclosed by the agent, and what is worse, if the relationship between the HCI and the agent is not a continuing relationship, the agent may solicit those candidates that are accepted by the HCI. Another shortcoming of agency services is that the agent performs only a small portion of the placement process. Therefore, the HCI may find it necessary to procure other service providers for additional services not included in the agent's duties (e.g., foreign counsel, preparatory course providers, and INS (BCIS) attorneys). At best, the HCI can hope for a reduction in preparatory expenses for recruiting events, lower travel expenses because of fewer trips to the recruiting site and an increased number of preliminary candidates from which to make a selection. In brief, the HCI may experience lower costs up to the point of the offer, but any savings realized in recruiting may evaporate due to candidate attribution.

The second type of outside service provider which offers placement services to HCIs is a Modified Traveler Agency. MTAs have one distinct advantage for an HCI over any other type of placement service provider—immediate nurse placement. If acceptable candidates are available through an MTA, the direct costs to the HCI are normally lower than any other type of placement service provider at the time of placement because the MTA incurs all costs prior to the candidate's acceptance by the institution. Thus, the direct placement costs to the HCI are relatively low and easily calculable. Moreover, because the MTA continually recruits candidates for immediate hiring, the MTA, and not the HCI, assumes the risk of attrition (i.e., if an HCI loses a traveler nurse, a replacement can be immediately hired without prolonging the placement process).

Even with these advantages, the healthcare industry generally recognizes MTAs as the most expensive placement solution for an HCI to resolve its employment shortfalls. The expense comes from a combination of direct and indirect costs which accumulate over time after the traveler nurse is accepted by the HCI. The MTA charges the HCI for the traveler nurse's service over a predetermined time period. It is not uncommon for MTA fees to be thrice the rate of, and payable in addition to, the traveler nurse. Typically, an MTA invoices an HCI for all hours worked by the traveler nurse during the work week at 50%-150% higher than other HCI employees. Additionally, the MTA may require recruitment fees, travel and housing costs for the traveler nurse and even bonuses to be paid to the traveler based on the MTA's bonus schedule. An HCI is often required to enter into a long-term contract with the MTA for traveler nurses and the travelers themselves are bound to the MTA for a multi-year employment period. In such a relationship, if a traveler nurse quits the HCI prior to the end of the contract period, the HCI is obliged to accept a replacement from the MTA to fulfill the contract period. However, at the termination of the contract, the traveler nurse cannot automatically become an HCI employee. Often, at the completion of the contract period for the HCI, the traveler nurse has remaining commitment time with the MTA. The HCI can then either continue on with the traveler agreement or attempt to hire a replacement, thus being in much the same predicament as it was at the contract inception. Only when the HCI and the traveler nurse have fulfilled their respective contracts can the HCI hire a traveler nurse from the MTA. Otherwise, the HCI is responsible for paying an additional placement fee to the MTA to buy out the remaining contract period for either the HCI, traveler nurse or both. In addition to being expensive for the HCI, MTAs have yet another disadvantage that is not immediately apparent in that traveler nurses are as loyal to the hiring employer as other foreign nurse employees. As mentioned above, one advantage of hiring foreign nurse professionals is their propensity to remain with the hiring employer longer (often twice as long) than a domestic employer. Extending an employment service period increases the basis used to charge off the hiring expenses and lessens the occurrence frequency of hiring expenses. While traveler nurses may be more loyal to their hiring HCI, on average their employment service period is much less than nurse professionals acquired through other hiring mechanisms and therefore the basis for absorbing the additional expenses for traveler nurses is somewhat reduced in comparison to the other placement services.

Probably the most cost effective way for an HCI to place foreign professionals has historically been through a Foreign Labor Search firm (FLS). FLSs offer a wider range of support services to an HCI at a predetermined fixed rate fee per candidate accepted than by other types of placement service providers. Also, in general, a FLS is compensated on placed nurses rather than acceptable candidate nurses, thus the FLS, rather than the HCI, absorbs the costs for nurses that drop out and thereby bears much of the risk rather than the HCI. Other advantages that may be realized by the HCI include savings in travel expenses and, in general, all fees payable by the HCI are disclosed in advance (i.e., no hidden fees). The direct costs for which the HCI is responsible, in addition to the FLS's service provider fee, include: fees for other service providers (e.g., attorneys, foreign placement professionals, preparatory course providers, etc.); many government fees (e.g., visa application filing, state licensure, etc.); and most quasi-government fees. Normally, it behooves the FLS to disclose all fees in advance because its compensation is based on placed foreign nurses. Should a billing issue arise during the placement process, it might jeopardize the completion of the placement and the FLS's compensation.

An FLS service provider has a vested interest in making the process move along smoothly to a successful placement, but not in expediting the placement process. The FLS placement process is a methodical concatenation of the placement subsets in which the FLS is responsible. It also makes economic sense for the FLS to postpone invoking its role in the placement process until the candidate has successfully completed the HCI's parts of the process. From the foregoing, it should be apparent that while direct costs might be somewhat lower using a FLS over other types of placement service providers (substantially due to the HCI being responsible for paying one set of direct costs for each successfully placed candidate), indirect costs may be higher. The ultimate goal of the FLS is to successfully place a candidate in an HCI and not to shorten the placement process. The FLS placement process works on the premise that by taking a little longer on each candidate, attrition is reduced which, when measured over a plurality of candidates, has the benefit of somewhat reducing the placement period. Still, FLS placement service providers are markedly more expensive, in terms of indirect costs alone, than any other placement service except the MTA placement service.

Recently, placement service providers have found it necessary to branch out into other areas in the search for qualified candidates for placement in the U.S. Larger service providers have sought to gain control of accredited educational institutions that instruct students in a particular profession. This is especially prevalent among agents and MTAs which have well established infrastructures in a foreign country, and the financial wherewithal to consummate such a transaction. Of course, this type of relationship inexorably leads to a greater number of less experienced candidates vying for employment opportunities which predominantly call for more experience than possessed by entry level candidates. However, given the extremely lengthy placement times associated with the prior art placement processes, often a fresh graduate candidate will have the experience necessary to fulfill the employment position prior completing the process (note from FIG. 2 that the minimum placement time for any candidate is between 75 and 114 weeks, excluding domestic licensure).

### SUMMARY OF THE INVENTION

The present invention is directed to a system, method and software program product for achieving the maximum efficiency in placing foreign professionals in the United States for employment. Initially, a placement service provider pre-screens applicant candidates and accepts them into the placement process prior to the applicant candidates accepting offers from an employer. Once accepted into the placement process, preliminary candidates are interviewed by employers for open positions within the respective employers' health care facilities. Another distinction is that the present invention obtains and maintains a predetermined balance of candidates in various stages of the placement process, and having a mix of clinical experience. A snapshot of the candidate pool, after the process reaches an equilibrium, reveals that predetermined proportions of the candidate pool are identified with specific placement processing stages (or groups). Maintaining this proportional mix of candidate groups enables the placement service provider to better manage the candidate pool based on the needs of the candidates in the respective groups. The proportion for each candidate group is normally considered static but may be adjusted to accommodate changing market and employer conditions. Another factor in determining how the candidate pool is distributed among the respective groups is the likelihood that candidates will drop out in the early stage groups rather than in the latter stages. Therefore, candidates in the initial stage groups make up a greater proportion of the candidate pool than candidates in latter stage groups in order to replenish dropouts. The placement service provider can then guarantee a placement date for an employer based on the candidate's group since the individual candidate groups are populated based on the likelihood of candidate attrition (in addition to the management burden on the service provider for the group). This date guarantee shifts the risk from the employer as was traditionally assumed in the prior art.

Other features of the present placement process are more specifically directed to decreasing the candidate processing time, thereby lowering the indirect costs to employers. One feature for reducing processing time is to integrate the control and management of candidates with a single placement service provider (similar to a turn-key operation). The control of candidates in prior art placement processes was more of an ad hoc function relegated to the employer. Because control of the present process rests with a placement service provider, whose primary function is placing candidates rather than an employer in the business of providing health care, the placement process can be optimized by the placement service provider. One placement optimization involves performing multiple sub-processes (e.g., recruiting, examination (including minor sub-processes of preparatory coursework, CGFNS, NCLEX, TOEFL, TOEIC, IELTS, TWE and TSE), BCIS processing, visa screen, embassy processing and physical placement) simultaneously rather than sequentially as in the prior art. Thus, the cumulative placement processing time can be reduced over the prior art even if the time required to accomplish each sub-process remains essentially unchanged. However, not all sub-processes can be initiated at the same time; instead a trigger event must occur prior to initiating certain sub-processes. In the prior art, the trigger event was always the successful completion of the prior sub-process (or subpart) of the placement process, thus the prior art subparts were managed essentially as discrete sub-processes and performed sequentially. By contrast, the present invention identifies trigger events which signal the occurrence during the performance of a particular subpart but signal that another sub-process can be initiated even though the present sub-process has not yet terminated (referred to internally as tightly coupling the sub-processes). The two sub-processes are performed simultaneously until the termination of one or the other subpart.

Another optimization is directed to proactively managing the candidate pool based on evaluating candidate performance and maintaining the predetermined balance of candidates in various stages of the placement process. Thus, the processing time associated with each sub-process may be reduced on a per-candidate basis over the prior art, thereby lowering the cumulative placement processing time. A candidate's progress in the placement process is closely tracked using a tracking application. Candidates who do not progress as expected are identified in the initial stages of the placement process and may be dealt with while their cost of the process is relatively low (i.e., less time in the process). Poorly performing candidates are more readily replaced in the early stage groups because the initial stage groups are more densely populated. Additionally, upon the determination that a group is below its quota of candidates, candidates in predecessor groups are encouraged to reach preset milestones ahead of schedule and advance into the deficient group, thereby bringing the candidate pool back to equilibrium.

Finally, because the control and management of the present placement process is centralized with the placement service provider, candidates can be prescreened for the formal qualifications of their profession early in the placement process. Employment and educational documentation necessary for testing or BCIS processing (references, education and employment records, etc.) is required from candidates by the placement service provider in the initial stages of the placement process. Candidates with problematic employment and education documentation and/or histories are identified early in the placement process, thus enabling the placement service provider to further evaluate the candidate's viability in the process prior to formally submitting the necessary documentation. Similarly, criminal background checks are performed by the service provider prior to the candidate entering the BCIS processing subpart. Candidates who cannot demonstrate “good moral character” are identified early in the placement process which gives the service provider the maximum time to rehabilitate the candidate's background prior to formal BCIS processing. Alternatively, if it is necessary to dismiss a candidate for having deficient qualifications or having a criminal background, the candidate is dismissed early in the placement process and more readily replaced as described above.

### BRIEF DESCRIPTION OF THE DRAWINGS

The novel features believed characteristic of the present invention are set forth in the appended claims. However, the invention itself, as well as a preferred mode of use, further objectives and advantages thereof, will be best understood by reference to the following detailed description of an illustrative embodiment when read in conjunction with the accompanying drawings wherein:

FIG. 1 is a diagram depicting the discrete subparts of a process for placing foreign professionals in the sequence in which they are performed in accordance with the prior art;

FIG. 2 is a logical diagram for the prior art placement process for a specific type of foreign professionals (e.g., nursing professionals) which depicts the processing time necessary to complete each subpart based on a candidate's group type;

FIGS. 3A-3F are flowcharts illustrating an abbreviated view of the prior art placement process for placing foreign nurse professionals in the United States;

FIGS. 4A and 4B are diagrams of candidate group types conceptually represented as candidate group types by a proportion of the entire pool of screened candidates in accordance with the present invention;

FIG. 5 is a block diagram depicting placement service provider architecture in accordance with an exemplary embodiment of the present invention;

FIG. 6 is a flowchart depicting a process for tightly coupling subparts of the placement process for implementation in an integrated placement process for acquiring foreign healthcare professionals for domestic service in accordance with an exemplary embodiment of the present invention;

FIG. 7 is a flowchart depicting an integrated placement process for acquiring foreign healthcare professionals for domestic service within a predetermined time period in accordance with an exemplary embodiment of the present invention;

FIG. 8 is a logical diagram illustrating a process for placing foreign professionals in accordance with an exemplary embodiment of the present invention;

FIG. 9 is a logical diagram depicting the present placement process for placing nursing professionals and is depicted along with corresponding processing time necessary for completing each placement subpart based on a candidate's group type in accordance with an exemplary embodiment of the present invention;

FIG. 10 is a diagram of a placement process illustrating a general sequence in which the subparts of the placement process are performed in accordance with an exemplary embodiment of the present invention which contrasts the diagram of the prior art process depicted in FIG. 1; and

FIG. 11 is a bar chart representing cumulative indirect costs to an employer for placing a foreign professional.

Other features of the present invention will be apparent from the accompanying drawings and from the following detailed description.

### DETAILED DESCRIPTION OF THE INVENTION

The placement of foreign professionals can be an extremely onerous and expensive process for achieving the maximum efficiency employers as described above with respect to hiring nursing professionals. At first blush, an employer's Human Resources (HR) department (e.g., a Health Care Institution (HCI) HR), would seem to be a logical entity for placing foreign candidates within the institution. The institution's HR has established procedures and protocols for domestically recruiting employees, markets the employer to potential domestic candidates, understands local laws regarding professional education and licensing, and may even have significant domestic contacts for supporting its role as a recruiter. However, even an employer's HR with extensive domestic experience for internally placing professionals is typically not proficient with international recruiting and/or placing of foreign professionals and, in a worst case scenario, might be completely ineffectual with potential foreign candidates.

Hence, the advent of placement service providers which provide employers with assistance for placing professionals for a fee. Even though each type of service provider discussed above provides some advantage for an employer (i.e., the HCI), none address the paramount cost issue of increasing indirect expenses for the employer. In fact, the employer itself does not often recognize the existence of indirect costs, or if indirect costs are appreciated, they are not accurately reflected in the bottom line. The employer does not often appreciate the correlation between indirect costs and inefficiencies in the placement process. Instead, employers tend to pass indirect costs off as a necessary and irreducible expense of doing business.

In accordance with exemplary embodiments of the present invention, indirect costs are fully appreciated as key costs associated with the placement process and the costs' magnitude as a measure of the placement process' innate inefficiency. Therefore, in addition to reducing the direct placement costs to an employer by guaranteeing candidate placement, a placement date is also specified. In accordance with other aspects of exemplary embodiments of the present invention, indirect costs are further reduced to the employer by providing comprehensive placement services for foreign professionals. Thus, an employer's HR is more able to focus on the placement functions which it is best suited and most experienced (i.e., internally placing domestic professionals). Still another aspect of some exemplary embodiments of the present invention is that once the placement process is operating, an employer may select candidates for placement within a range of placement dates depending upon the employer's needs.

The present placement process may be described as an integrated placement process for acquiring foreign healthcare professionals for domestic service by implementing a plurality of tightly-coupled placement sub-processes. Integration of the placement process is realized by hermetically scaling the placement process as an object, that from the perception of an employer, requires only one input (e.g., a candidate selection), one supply (e.g., a fee) and creates one output (e.g., a placed employee). In addition, the tightly-coupled sub-processes are managed and controlled by a single entity, thus, the entire placement process may be tightly controlled. Control of the placement process is integrated and maintained by a service provider that assumes the risk of its success. In accordance with exemplary embodiments of the present invention, the placement sub-processes comprise a plurality of tightly-coupled sub-processes, or subparts, which are linked together in such a way that are often dependent upon each other, communicate directly with one another and share resources for achieving the common goal. One distinction of the present invention's tightly-coupled sub-processes is that the subparts of the placement process are not seen as being separately integrated, as is the case of the prior art, primarily because each prior art subpart service provider assumes no risk for the success of its own subpart, much less for ultimate placement success. By contrast, with regard to the present placement, one entity assumes the risk for the entire placement process. Subparts of the process are not performed as a series of discrete sub-processes, or in any strict sequential order, but instead are triggered by the occurrence of an event related to the particular sub-process. The triggering event may be the completion of a prior subpart, but might also be the occurrence of an internal event within a subpart. Thus, internally occurring events may act as milestone events for invoking subsequent sub-processes, even while the previous subparts continue to be processed. Thus, subsequent subparts may be invoked through the occurrence of a milestone in a prior subpart and the two sub-processes in parallel.

Service providers who provided prior art placement services fail to recognize that the entire placement process can be integrated and thereby performed or controlled by a single service provider rather than multiple providers. Moreover, typically placement service providers are not motivated to move away from the prior art placement process paradigm toward integrated placement process because employers (HCIs and others) do not always recognize the advantage of incurring higher direct costs from a single service provider. Since much of the savings over the prior art placement process relates to lowering indirect placement costs, employers simply do not recognize the advantage because indirect costs are often presumed to be a consequence of something other than the placement process, thus savings could not be realized by optimizing the placement process. While employers may recognize that some indirect placement costs could be rightly attributable to inefficiencies in the prior art placement process, indirect placement costs are difficult to calculate, so any gains that might be realized from an integrated placement process might be considered by the employers to be subjective due to the difficulty in quantifying the indirect placement costs. Additionally, placement service providers are extremely reticent to bear the total risk of failing to place a candidate; therefore, even if a prior art placement process could be integrated into some of the placement sub-processes, placement service providers would not be motivated to do so unless a mechanism could be devised for compensating the service provider for taking on the additional risk. Still further, even if all of the advantages for moving toward an integrated placement process were known and service providers were motivated to implement an integrated placement process, no platform exists in the prior art for implementing a plurality of placement service subparts as a single integrated process. Furthermore, the prior art approach to placing candidates with an employer simply does not provide a mechanism for implementing a placement process of tightly-coupled sub-processes capable of executing separate sub-processes in parallel when triggered by the occurrence of an event, wherein the event may be internal to a separate sub-process.

These and other exemplary embodiments of the present invention will be discussed below with regard to the corresponding figure drawings. The following exemplary embodiments will be discussed with regard to the placement of foreign nursing professionals, although ordinary skilled artisans in the relevant arts will readily understand the applicability of the present invention to other vocations, whether professional, semi-professional, skilled, trade, etc., or whether the vocation relates to the service or product sector of the economy.

The prior art placement process can be described as a concatenation of discrete placement subparts that are sequentially executed. Normally, an employer will not authorize a service provider to take on a candidate until the candidate successfully completes preceding subparts of the placement process. Only when the employer recognizes that a candidate has successfully completed a placement subpart would the employer authorize the next service provider in the process to proceed with the candidate. Since the prior art placement process treats every placement subpart as a discrete sub-process, the length of time for a candidate to finish the prior time placement process is equal to the sum of the time for a candidate to complete each subpart of the process. By contrast, the present placement process tightly couples the individual subparts of the present integrated placement process.

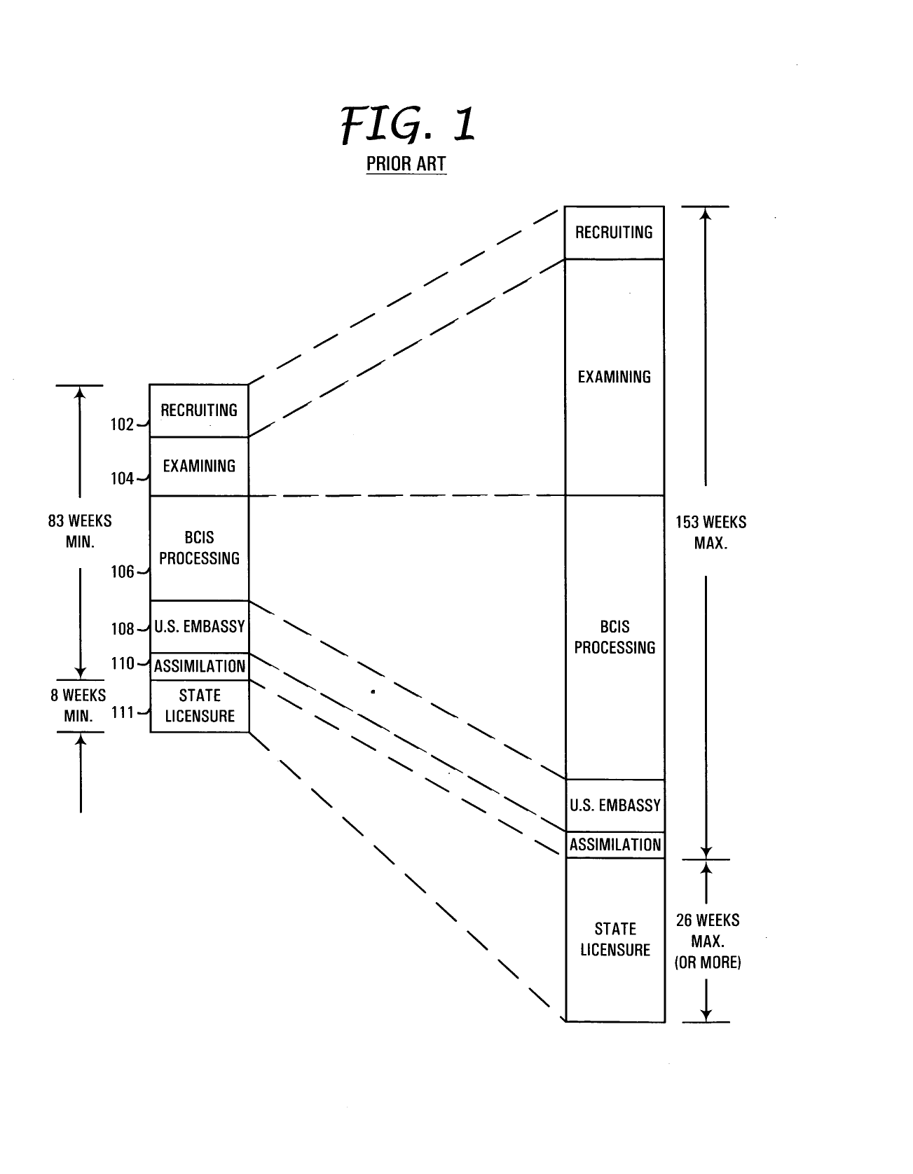

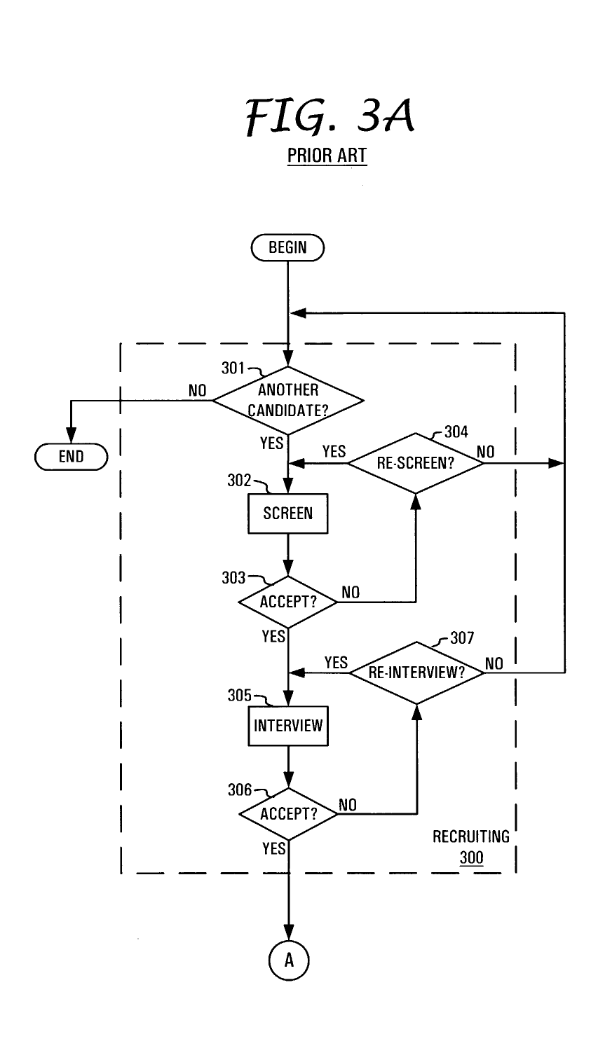

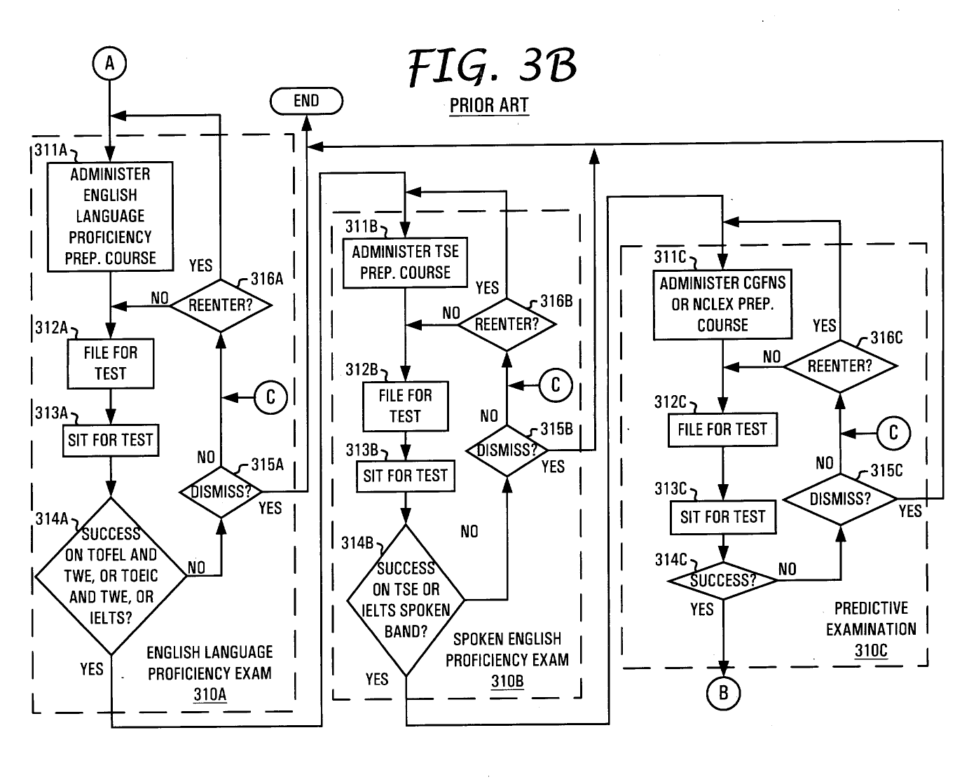

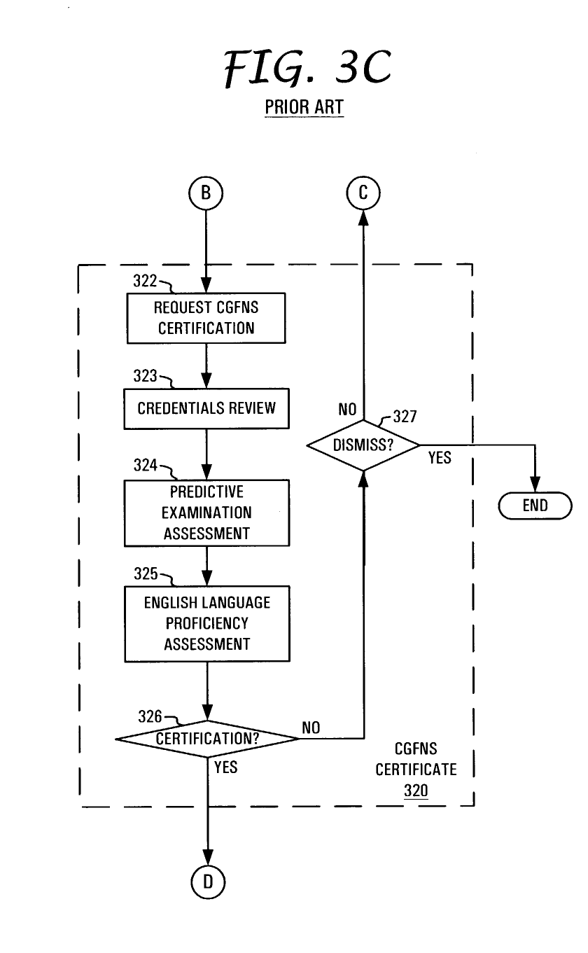

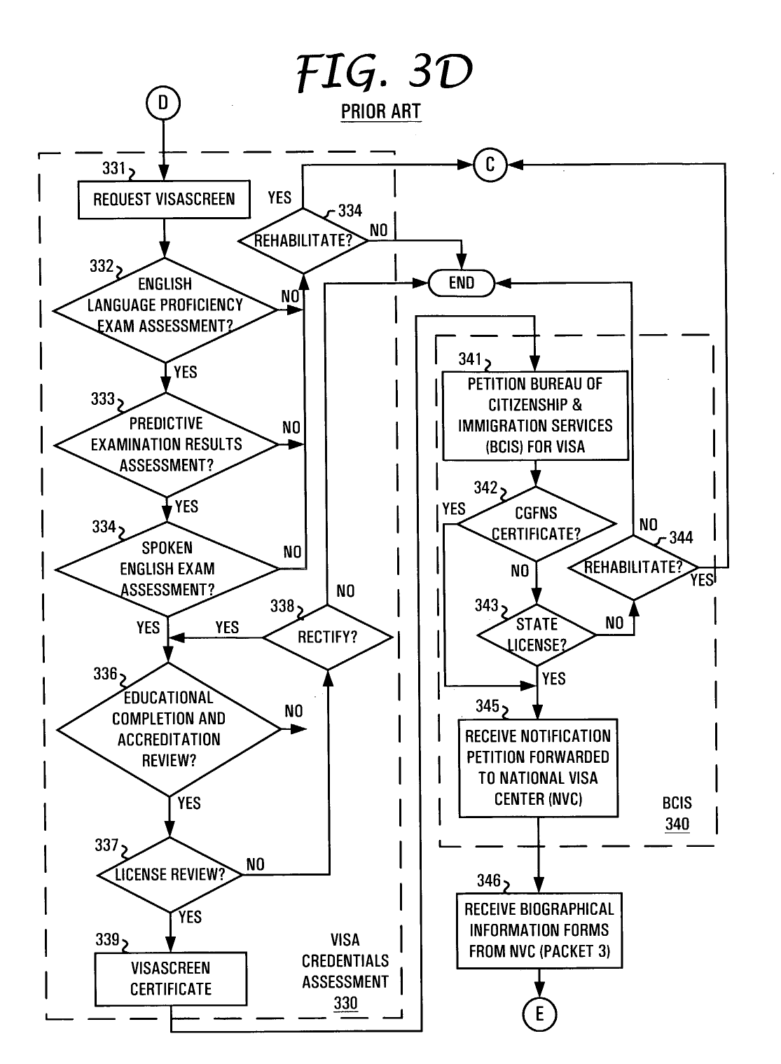

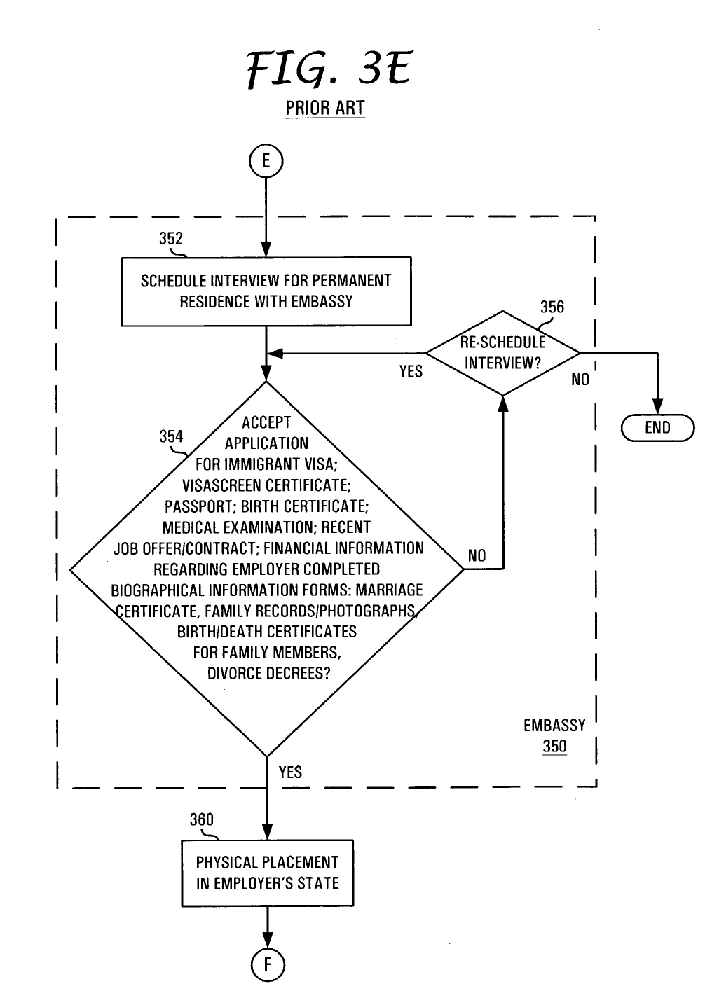

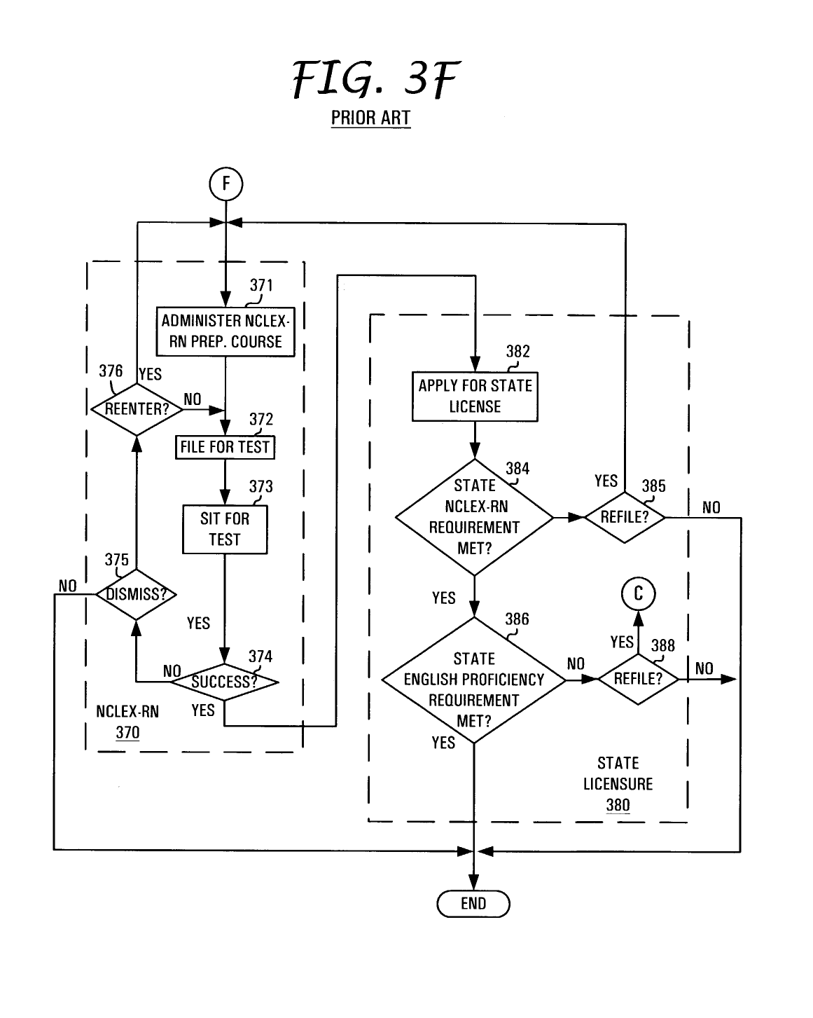

FIGS. 3A-3F are flowcharts illustrating an abbreviated view of the prior art placement process for placing foreign nurse professionals in the United States. It should be understood that the placement process depicted in the figures is merely representative of the prior art nurse placement process and for clarity has been abbreviated for the discussion of the present invention. The description of the prior art placement process is not a limitation for the processes of the present invention. Before describing the prior art placement process, recall that the prior art placement process is divided into discrete subparts or sub-processes, similar to those illustrated in FIG. 1, and each of which are sequentially executed. As depicted in FIGS. 3A-3F, the major discrete subparts include: recruiting 300; examination 310; certification 310, visa screen 330, certificate BCIS 340; embassy 350; physical placement 360, NCLEX 370, and state licensure 380. Notice also that each of the seven subparts is further divided into discrete minor subparts which are themselves sequentially executed sub-processes. In some cases (e.g., examination 310310 and BCIS 340), the minor subparts are divided into still smaller discrete subparts that are also performed sequentially within the respective minor subpart.

The prior art placement process begins by recruiting a candidate as shown in recruiting subpart 300. The recruiting sub-process is a logical process loop that iterates through all available applicant-candidates for finding qualified preliminary candidates for an employer to interview. Recruiting begins with the logical step of checking for available applicant-candidates (step 301) and when answered in the affirmative, an available applicant-candidate is screened for the minimum qualifications necessary to be interviewed (step 302). Screening is an informal step which is necessary for uncovering an applicant-candidate's personal or professional deficiencies that might disqualify the applicant for the position, deny their entry into the U.S., or that might suggest the applicant will not assimilate into the employer's organization. It is the responsibility of the screener, which may be a service provider such as an organizing agent, to provide only pre-qualified candidates to the interviewers for entering the placement process. Essentially, it is the responsibility of the screener to verify that applicant-candidates have completed an educational curriculum separate from their nursing education, have graduated from a certified approved nursing program, and have received both classroom instruction and clinical practice in the nursing field. It is expected that the screener will identify applicant-candidates who do not meet the minimum qualifications for continuing in the placement process. For example, in order for a nurse to sit for either the Graduates of Foreign Nursing Schools (CGFNS) qualifying exam or the National Council Licensure Examination (NCLEX), a nurse must be a first-level nurse licensee (i.e., defined by the International Council of Nurses (ICN) and generally recognized as being equivalent to a registered nurse). Additionally, a nurse must hold both an initial and a current registration and/or first-level licensure. It is therefore the task of the screener to evaluate each applicant-candidate's education and registration credentials to verify that applicant-candidates meet all of the registration requirements in order to be licensed as a professional in a nursing field and to sit for the CGFNS and NCLEX examinations, and thus continue the process. A screener will often be responsible for verifying the authenticity of transcripts and the certification of nursing programs and evaluating the applicant-candidate. At this stage of the placement process, a screener may make initial assessments of an applicant-candidate's demeanor, emotional stability, suitability for the position, etc. in a further effort to assess the likelihood of a successful placement. Applicant-candidates that are accepted (step 303) continue in the recruiting sub-process; however, those that do not are not necessarily excluded from candidacy but might instead be re-screened (step 304) depending, of course, upon the seriousness of the candidate's shortcomings and the employer's hiring needs. If the candidate does not pass the initial screening, the process reverts to step 301 to check for another available candidate.

Assuming a candidate passes screening, and therefore meets the minimum qualifications for continuing in the recruiting sub-process, the interviewing sub-process begins (step 305). Interviewing preliminary candidates for continuing in the placement process (i.e., being made a offer) is almost the exclusive domain of the employer, with the possible exception of a MTA placement service provider which essentially hires a candidate as a traveler nurse for temporary placements by employers. Preliminary candidates that are accepted by the employer into the placement process are made an offer of employment that is contingent upon the candidate's successful completion of the placement process (step 306). Preliminary candidates that are not initially given an offer might be re-interviewed by the employer again based on the preliminary candidate's qualifications and the hiring criteria of the employer (step 307). If not, the preliminary candidate is excluded and no longer considered an available candidate and the placement process again reverts to step 301 to check for other available candidates. Candidates that receive an offer of employment from an employer move on to examination subpart 310 of the placement process.

Note that the recruiting sub-process is divided into discrete minor sub-processes (i.e., screening, decision to re-screen, interviewing and deciding to re-interview), as alluded to above. One should also understand that many of the minor sub-parts are performed or managed by disparate entities. This lack of integration adds to the processing time for placement because the disparate entities must communicate the results of the previous step prior to performing the next step in the recruiting sub-process.

The ultimate goal of the examination sub-process is for an accepted candidate to become certified under the Commission on Graduates of Foreign Nursing Schools and pass the CGFNS qualifying exam, then pass the NCLEX examination as one or both are routinely required for licensure by states. However, in order to be eligible to sit for the CGFNS and NCLEX examinations, as well as obtain a state nursing license, a foreign nurse candidate must demonstrate English language proficiency through a formal testing regime. Demonstrating proficiency in both written and spoken English is necessary for immigration into the U.S., but only written proficiency is required for sitting for the CGFNS and NCLEX examinations. English language proficiency testing may take several forms including the Test of English as a Foreign Language (TOEFL) examination, Test of Written English (TWE) which is normally administered simultaneously with the written TOFEL, Test of Spoken English for Professionals (TSE-P) which is orally administered separately from the TOFEL examination, Test of English for International Communication (TOEIC) or International English Language Testing System (IELTS). Sitting for the CGFNS and NCLEX examinations requires passing the TOEFL and TWL tests, or the TOEIC and TWL tests, or the IELTS test. In addition, for immigration into the U.S., the candidate must demonstrate proficiency in spoken English by passing either the TSE of the IELTS spoken band for the visa credentials assessment (visa screen 330). Those preliminary candidates whose native language is English and who attained a nursing degree from an institution where the instruction and textbooks were in English (including those located in Australia, Canada (except Quebec), Ireland, New Zealand or the United Kingdom) may be exempt from English language proficiency testing. Other English proficiency testing options include the Michigan English Language Assessment Battery (MELAB) in situations where an advanced level of English language competence must be demonstrated, as well as the Secondary Level English Proficiency (SLEP) Test and Speaking Proficiency English Assessment Kit (SPEAK) for less formal situations where demonstrating a high level of proficiency is not necessary.

In the depicted prior art placement process, preliminary candidates must demonstrate both professional competence and English proficiency through a variety of tests. Most minor subparts of the examination sub-process comprise identical steps (e.g., administering preparatory course for a particular test, filing for the test, administering the test, determining testing success, deciding whether to dismiss the candidate, and finally, deciding whether to provide supplementary coursework or merely re-file for and re-administer the test). Even though most minor subparts of the examination process are comprised of identical steps, generally each step is performed by a separate entity and is therefore necessary for the individual entities to communicate with one another regarding the candidate's status. An examination subpart may require the participation of several service providers in addition to the participation of the employer. For example, administering a test preparation course is carried out by a service provider that is competent with that particular type of test. While administering the test is strictly a function of a pseudo-government organization, in order to maintain the integrity of the test, test administration is rarely ever delegated to a preparation service provider. However, the employer may be responsible for performing other steps in an examination subpart such as making application for a candidate to be tested (filing), and paying or administering payment of the requisite filing fees. Poor communication, especially between service providers, is a major cause of placement processing delays resulting in increased indirect costs to the employer.

Normally, an employer will retain all decision authority in the process by deciding whether the testing requirement had been satisfied and if the candidate should move to the next minor subpart (although each test does have a mandatory minimum scoring requirement), determining whether or not to retain the candidate in the process based on the candidate being unsuccessful in achieving a pre-specified test result, and deciding whether to re-file for the test without incurring the added expense of more coursework for those candidates that achieve a sub-par test score but are to be retained. Some service providers guarantee a passing test score, in which case the decision is made on other factors such as testing dates, etc. Thus, not only is it necessary for the various service providers to interact efficiently together to reduce processing time, they must also be responsive to the employer's pronouncements in order to minimize the processing time for candidates.

A candidate must successfully complete prerequisite testing minor subparts (i.e., English proficiency subparts) before sitting for professional competency testing. If a candidate is dismissed from the process, then the placement time necessary for filling an opening is significantly increased and the employer incurs higher indirect costs associated with that placement. Therefore, an employer must decide whether it is more efficient to retain a candidate in the placement process (even though the candidate has not demonstrated the proficiency necessary to progress) or to dismiss the candidate outright. Looping within a prerequisite minor sub-process increases the placement processing time, but in some cases the delay might be justified, especially for candidates that have completed a large portion of the examination subpart. However, in either case the employer will incur additional costs, usually both direct and indirect, thus becoming a question of minimizing the additional expenditures. These shortcomings will become more apparent with the description of the prior art examination sub-process as depicted in FIG. 3B.

A preliminary candidate in examination subpart 310 must demonstrate proficiency with the English language (i.e., the written proficiency requirement 310A and the spoken proficiency requirement 310B). Demonstrating written proficiency in the English language is necessary for a candidate to progress to either CGFNS 310D and CGFNS certification 320 or alternatively sitting for the NCLEX-RN 370 as a prerequisite of the CGFNS certification 320 Demonstrating spoken proficiency in the English language is necessary for obtaining a visa screen certificate (visa credentials assessment 330), which is necessary for immigration into the U.S. Because a complete understanding of the method of the prior art is not necessary for practicing the present invention, only the TOEFL minor subpart will be described in depth. However, it should be understood that although preparation for TOEFL 310A-B, TWE 310B, and TSE 310C minor subparts may be performed simultaneously, the testing frequency, times and test sites for the individual tests are independent of one another. Moreover, filing deadlines for testing and available seating at test sites vary widely (e.g., TOEFL applicants, administered as either a paper-based examination six times yearly or computer-based examination usually weekly, may register for reserved paper-based testing usually until a month prior to the test day but at some testing sites may continue to register as stand-by right up until the test date). Some of the current testing requirements for a foreign nursing professional to immigrate into the U.S. are listed below in Table I (which is not considered to be an exhaustive survey for the testing requirements).

TABLE I

| | | | | | Result | | |
|---|---|---|---|---|---|---|---|
| | | | | | Turn- | | |
| | | Dates | | | around | Test | |
| Test | Frequency | (2003) | Application Time | Grade | time | Location | Comments |
| CGFNS | 3 times a | Usually 3 | 2-4 weeks to | | 8-10 | UK, Kuwait, | NO premium processing |
| | year | dates (4 | open a file | | weeks (up | Philippines | |
| | | dates in | | | to 4 weeks | | |
| | | 2003) | | | for mail) | | |
| NCLEX | min. 91 | Monday thru | 1st time takers | Set by | State | Any Pearson | In a few instances a |
| | days after | Friday year | must be offered | State | nursing | Testing | passing NCLEX score |
| | testing | round | an appointment | | board will | Center | from one state can be |
| | unless | | within 30 days | | send out | | used in the licensure by |
| | longer for | | and 2nd time | | your results | | examination process in |
| | state | | takers must be | | approxi- | | another state; NCLEX can |
| | | | offered one within | | mately 1 month | | also be used to apply for |
| | | | 45 days after | | after the | | Visa Screen in stead of a |
| | | | state supplies and | | test (quicker | | CG certificate; 44 out of |
| | | | ATT | | in some | | 50 states also require a |
| | | | | | states) | | CGFNS certificate |
| TOEFL | 6 times a | January 18 | Immediate if done | 540(207 | 2 wks | Guam and | NO premium processing |
| | year | March 14 | on line | computer- | computer; 5 | American | |
| | | May 10 | | ized) | wks paper | Samoa | |
| TWE | 6 times a | January 18 | Immediate if done | 4.0 | 4-5 weeks | | |
| | year | March 14 | on line | | after test | | |
| | | May 10 | | | (sent with | | |
| | | | | | TEOFI) | | |
| TSE | 12 times a | 3 Fridays | Immediate if done | 50 | 4-5 weeks | Guam and | NO premium processing |
| | year | 9 Saturdays | online | | to be mailed | American | |
| | | | | | | Samoa | |
| IELTS | No more | At least | Immediate if done | 6.5 and | 2 weeks | 250 test | Need a score of 6.5 |
| | than once | once a | in person | IELTS | after test; | centers | overall and a spoken band |
| | every 90 | month (soon | | Spoken | scores are | worldwide | score of 7.0 to use for |
| | days | to be 48 | | Band: 7.0 | sent directly | | CGFNS; Scores valid for |
| | | dates/year) | | | from the | | 2 years |
| | | | | | test center | | |
| TOEIC | | No specific | | 725; and | | Public | Need a score of 725 in |
| | | dates | | TWE: 4.0 | | Sessions | addition to TWE of 4.0 |
| | | | | TSE: 50 | | world wide | and TSE of 50 |
| | | | | | | or On-site) | |

The written English language proficiency exam 310A minor subpart begins by administering a preparatory class for English which is specific to the type of examination to be taken by the candidate (step 311A) and upon completing the required coursework and filing for the examination itself (step 312A). Next, the examination is administered (step 313A) and the outcome determines whether or not the candidate proceeds to the next minor subpart of the examination sub-process (i.e., Success on TOFEL and TWE, or TOEIC and TWE, or IELTS is necessary for proceeding (step 314A)). A candidate that does not achieve a required minimum score may not be summarily dismissed, but instead the placement process administrator determines whether or not the candidate might be retained in the placement process (step 315A). If a candidate performs extremely poorly on the proficiency examination, then the candidate may not be retained in the process. Only minimal time in the placement process has elapsed at this time, therefore candidates who perform poorly at this stage may be dismissed since the placement time will not be impacted greatly and because a poor showing here may indicate that the candidate will have difficulty with other examination requirements, especially the spoken English portion which historically has been the more difficult proficiency test for nurse candidates. If, however, the candidate's performance is merely sub-par, remedial measures might then be employed to salvage the candidate without unduly increasing the placement time. If a candidate is to be retained in the process, it is then decided what type of remedial action will best ensure the candidate's success at the lowest cost to the employer (i.e., whether to merely re-file for the examination or to reenter all or part of the preparatory class (step 316A)). However, because the examination is normally administered at specific intervals (e.g., two-month for the TOEFL examination), the lag time between test dates may necessitate the candidate take some type of refresher course prior to retaking the test. Once written proficiency 310A minor subpart has been successfully traversed, the examination process proceeds to the spoken proficiency minor subpart (310B). This process subpart, as well as the predicative examination subpart 310C, is executed substantially identical to the written English language proficiency exam 310A minor subpart and therefore will not be described. However, it should be understood that the CGFNS Certification Program, as well as the CGFNS Qualifying Exam, were created to serve as a predictor evaluation process and corresponding exam for foreign nurses to more accurately forecast which candidates were likely to meet the requirements for licensure as registered nurses in the U.S.

In certain situations, successfully passing the NCLEX-RN (rather than taking the CGFNS predictor examination) may suffice for the CGFNS certification; however, most states require taking the CGFNS for licensing. This is important in cases where a placement service provider is responsible for only placing the foreign nursing professional in the U.S. and not in a position with the employer. As mentioned above, achieving a satisfactory score on the particular written English language proficiency exam 310A and predicative examination 310C minor subparts are prerequisites for entering the CGFNS certification program (i.e., CGFNS certificate 320). The successful completion of CGFNS is a prerequisite for ultimately sitting for the NCLEX-RN test for foreign nurse candidates, although in certain situations a foreign nurse may sit for the NCLEX-RN test, but not obtain a license until immigrating to the U.S. Therefore, logically the first minor subpart of the professional proficiency portion of the examination sub-process is predicative exam 310C, followed by minor subpart NCLEX-RN 370, and finally state licensure 380. However, since it is not necessary for foreign nurses who have successfully passed the NCLEX-RN to sit for the CGFNS, the candidate may secure all requirements for the embassy interview without taking the CGFNS. Then, upon placement in the U.S., it becomes the responsibility of the employer for the nurse to pass both the NCLEX-RN and the CGFNS examination for licensure in the particular state in which the employer is geographically located. Situations may arise where the placement service provider duly places a nurse in the U.S. but the nurse never qualifies for practicing in the U.S. In that situation, the unqualified is generally allowed to remain in the U.S., but the employer must place another candidate to fill the unqualified nurse's position. Thus, the employer receives no benefit whatsoever from the service provider and generally does not even have leverage with the nurse (i.e., initiating deportation proceedings if the nurse fails to use best efforts to pass the examinations.)

Turning now to FIG. 3C, the CGFNS certification process in depicted as a sub-part of the prior art placement process. The CGFNS Certification Program is designed specifically for first-level, general nurses educated and licensed outside the U.S. who wish to assess their chances of passing the U.S. registered nurse licensing exam. The certification program is comprised of a credentials review, the written English language proficiency exam 310A, and the one-day qualifying CGFNS exam 310C. The certification process is administered by the International Commission on Healthcare Professions (ICHP) of the Commission of Graduates of Foreign Nursing Schools. The process begins with filing a request for certification to the CGFNS (step 322). With the request are all documents concerning the English proficiency and predictive examinations (e.g., test results, location and date taken) and information about the foreign nurse's education and licensing including educational transcripts, mandatory test results and all licenses for any jurisdiction in which the candidate is or has been licensed. Next, the Credential Evaluation Service of CGFNS performs a review of the candidate's credentials and the educational institution where the candidate was educated, and the licensing requirements of the jurisdiction where the placement candidate is/was licensed. The objective is to assess the candidate's education and licensing from the perspective of that required in the U.S. Results of the predictive examination 310C (step 324) and the written English language proficiency examination 310A (step 325) are also reviewed by the CGFNS. If each of the three parts of the program for certification are met, a CGFNS certificate is issued to the candidate (step 326). If not, a decision whether or not to dismiss the candidate is the made by the placement administrator (step 327). If the candidate is retained, (s)he reverts back to the part of the placement process which is deficient for remedial processing. This may be as uncomplicated as obtaining additional education/employment/licensing records or as difficult as re-entering a testing sub-part.

Having completed the testing (step 310) and the CGFNS certificate (step 320) sub-parts, the candidate proceeds to the visa credential sub-part 330 where the candidate's examination performance is scrutinized for the issuance of a visa screen certificate. Essentially, a foreign nurse professional applying for a permanent (immigrant) visa must obtain a visa screen certificate prior to BCIS processing. The visa screen credential assessment 330 includes demonstrating English language proficiency (written 310A and spoken 310B (a passing score on TOEFL and TWE or IELTS or TOEIC, and TSE or IELTS spoken band) (steps 332 and 334) and a passing score on either the CGFNS predictor exam or the NCLEX-RN 310C (step 333), a further review of the candidate's educational credentials (step 336) and a review of licensure documentation (step 337). If the candidate's records are in order, a visa screen certificate is issued (step 339). If not, the candidate may be given the opportunity for testing rehabilitation (step 334) or to rectify educational or licensure documentation (step 338) prior to dismissal from the placement process.

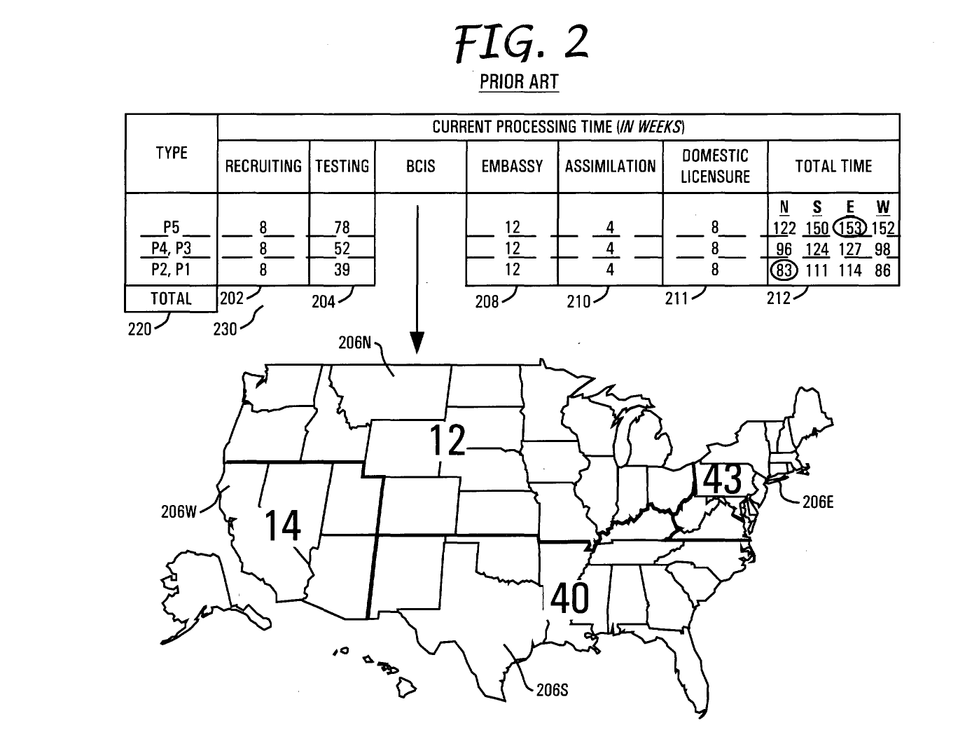

With a visa screen certificate, the candidate can proceed to the BCIS processing 340 subpart of the placement process administered by the Bureau of Citizenship and Immigration Services (formerly known as the Immigration and Naturalization Service (INS), now a bureau of the Department of Homeland Security (DHS). The BCIS determines which visa applicants should be granted an immigrant visa (initially a visa number) for permanent residence in the United States. An immigrant visa or Green Card (known technically as the Alien Registration Card (I-551) by the INS) provides evidence that the holder is eligible to enter and reside indefinitely in the United States as an immigrant or a permanent resident. The bulk of visa process 340 is performed by a regional BCIS office and is therefore subject to BCIS processing inefficiencies in that particular region (refer again to FIG. 2). The process begins by an employer (referred to as a sponsor) filing an BCIS I-140 under one of five categories EB-1, EB-2, EB-3, EB-4, or EB-5, at a BCIS Regional Service Center serving the area where the candidate will be employed (step 341). Often nurse professionals qualify for the I-1140 category EB-3 type petition in which the sponsor must include the filing of a labor certification and a permanent, full-time job offer. The candidate's CGFNS certificate is requested (step 342). Optionally, the candidate may already be licensed in a territory of the U.S., such as Saipan (step 343). The BCIS may require additional information from the applicant-candidate to complete the filing, including the candidate's personal information, references, completed criminal background questionnaire and personal interview. At various times throughout the process, the BCIS may issue Requests For Evidence (RFEs). RFEs must be responded to in a statutory time period in order to be timely and considered by the BCIS. Once the BCIS has determined that the candidate has met the filing requirements, the BCIS will require the candidate to be fingerprinted for a criminal background check. The BCIS schedules fingerprinting at an authorized site, usually a U.S. embassy, after a petition has been filed. Upon satisfactorily petitioning the BCIS, a criminal background check is performed on the candidate, usually administered by the Federal Bureau of Investigation (FBI). Once it has been determined that the candidate is of “good moral character” (i.e., no significant criminal background since age eighteen, no descriptive misrepresentations, or willful failure to support dependents, or connection to known terrorist organizations, the candidate receives notification that the petition has been forwarded to the National Visa Center (NVC) for processing (i.e. that requirements for immigration to the U.S. have been satisfied and a visa number is pending (step 345)).

Returning to step 345, even when the immigrant petition is granted, the criminal background check is favorable and the candidate's visa application is approved by the BCIS, U.S. law limits the number of immigrant visa numbers that are available every year. Thus, even if the BCIS approves a visa petition for a candidate, a visa number may not be allocated immediately. A finite number of visa numbers are authorized by the U.S. State Department each year, which also sets limits of the number of visas that citizens from a particular country are authorized. Furthermore, that number is divided between the northern, southern, eastern and western BCIS regions in the United States. These three factors further complicate the placement process by limiting the total amount of visas and adding a regional processing component to the BCIS review procedure. Additional factors may further complicate the BCIS procedure such as the type of visa being sought, availability of the alien, and the completeness of the alien's personal records and transcripts. Therefore, if it seems likely that a visa number will not be issued within a reasonable time, a decision must then be made as to whether the candidate should be retained in the placement process. If not, the process ends.

Once the candidate's visa number is pending (i.e., the issuance of a visa is imminent), the candidate receives a biographical packet from the NVC (so called Packet III) which lists the requirements and documents for presentation at the U.S. embassy. (step 346). These include the following non-exhaustive requirements:

Application for Immigrant Visa;

VisaScreen Certificate;

Passport;

Police report/criminal background check;

Birth Certificate;

Medical Examination;

Recent job offer/contract (Financial information regarding employer);

Completed biographical information forms:

Marriage Certificate;

Family records;

Family photographs;

Birth/death certificates for family members; or

Divorce decrees.

Turning to FIG. 3E, the U.S. embassy sub-part of the placement process is depicted as performed in the prior art. Initially, an interview is scheduled with the consulate of the U.S. embassy in the candidate's county (step 352). At this time, the candidate should have completed the required Packet III forms sent by the NVC and identified above (step 354). The candidate is then issued an immigration visa and can immigrate to the employer's state (step 360). Should some part of the Packet III requirements not be complete, the candidate will be required to re-schedule an interview with the embassy for further Packet III reviews (step 356).

Typically, once in the U.S., only then does the candidate begin state licensure in the prior art placement scheme. The state licensure sub-part of the placement process is an effective two-part undertaking NCLEX-RN 370 and state licensure approval 380. Although not explicitly depicted in the flowchart, commencement of NCLEX-RN 370 can proceed only after the candidate has received and submitted an Authorization to Test (ATT) from the licensing state to the National Council of State Boards of Nursing, Inc. (NCLEX-RN testing). The purpose of the ATT is to ensure that the candidate has met the state's other requirements for licensing prior to the candidate being permitted to take the NCLEX-RN. Here again, both CGFNS 310C and NCLEX-RN 370 minor subparts follow the identical process flow described above for administering preparatory classes (e.g., filing/registering for testing, administering tests and assessing test results, passing successful test takers to another minor subpart while deciding whether it is in the best interest of the institution to retain unsuccessful test takers in the process), and finally, administering remedial measures, such as preparatory classes, if necessary. Moreover, although CGFNS 310C and NCLEX-RN 310E minor sub-processes are essentially identical to other sub-processes, such as English proficiency examination 310A-B discussed above, the administration of professional proficiency testing is generally more constrained. For example, compared to the TOEFL examination, the CGFNS Qualifying Exam is administered only three times yearly which is fewer than a third of the number of worldwide TOEFL examination locations. Therefore, transportation to the testing site may be necessary. Since the NCLEX-RN examination is normally required by the state in which the candidate will be employed, filing for the examination is done through that jurisdiction. Additionally, the NCLEX-RN is a Computer Adaptive Test, meaning the test is administered exclusively on designated computer systems, restricted to the U.S. and its territories. Scheduling a candidate's initial testing dates is somewhat more flexible, usually within a month from the date of filing; however, the test can be retaken only after expiration of a three-month waiting period. Clearly, the opportunity exists for even longer delays and greater placement processing times due to the testing constraints required by professional proficiency testing administrators.

Upon successful completion of the NCLEX-RN 370, state licensure 380 minor subpart of the prior art placement process is completed. This sub-part includes applying for the state license (step 382), meeting the state's NCLEX-RN requirements (step 384), and meeting the state's English language proficiency requirements (step 386). As mentioned elsewhere above, the placement service provider's role in the placement process often concludes with the physical placement of the candidate at the employer's geographical location, so NCLEX-RN examination 370 and meeting the state licensure requirement 380 are left to the employer. Accomplishing these tasks increases the direct costs of placement to the employer substantially because during the time period in which the candidate is not licensed in the state, it behooves the employer to provide meaningful employment in a lesser capacity to ensure the candidate has the opportunity to study and does not either resign or return home. Once licensed in the employer's state, prior art placement ends the process.

The present invention is directed to placing foreign professionals with domestic employers without the inefficiencies of the prior art and thereby reducing the indirect costs due to the placement processing period. One cause of the inefficiencies of the prior art placement process is the lack of centralized control of the placement process. Another cause of the lack of centralized control is the prior art's treatment of the placement process as a plurality or dependent sub-process which is performed sequentially. Another source of the inefficiencies in the prior art is that the prior art service providers do not bear the risk of failing to place a professional; instead, service providers of the prior art services shift the risks associated with placement to the employer. Thus, an employer is forced to assume the risk and any indirect costs resulting from the materialization of inefficiencies in the placement.

In accordance with an exemplary embodiment of the present invention, with another aspect of the present invention, the placement service provides protection from losses, at least the direct losses, associated with candidates who drop out, withdraw, breach the placement agreement and candidates who cannot pass the examination requirements. The financial loses are minimized by bonding candidates through a third-party surety. Bonding may take several forms, but generally the surety assesses the risk of pay out based on guarantees made by the candidate and by the track record of the candidates screened by the service provider.

The present placement process overcomes the shortcomings of the prior art by implementing a plurality of tightly-coupled placement sub-processes into an integrated placement process for acquiring foreign healthcare professionals for domestic service. In practicing the present invention, a placement service provider controls the placement process, tracks candidates within the process and assumes the entire risk for its success, thereby shifting the risk from the employer. While logically the employer, or the employer's HR staff, exhibits some control over the placement process, it should be stressed that the employer's business is the primary focus of the enterprise and not the placement of foreign professionals in the enterprise. Moreover, even if the employer's HR staff is capable and experienced in placing domestic employees, placing foreign employers is a different process altogether. In accordance the present invention, a placement service provider, while not providing each discrete placement service, controls the entire placement process.

Additionally, the placement service provider assumes the entire risk for successfully placing the foreign professionals. One means of assuming the risk is to guarantee placement by a pre-specified date. If an employer's candidate drops out of the placement process, that candidate is replaced by another candidate who has an equivalent length of remaining placement processing time.

The present invention also reduces the indirect placement costs to the employer by reducing the duration of the placement process. Placement processing time is reduced when practicing the present invention by integrating the disparate subparts into a tightly-coupled placement sub-process. Discrete subparts or sub-processes are performed simultaneously by coupling sub-processes in such a way that they are controlled by a single entity, communicate directly with one another, and share resources. Placement processing time is further reduced by integrating a candidate placement tracking feature into the placement process for proactively monitoring a candidate's progress. By scrutinizing a candidate's progress, weak candidates are identified at early stages in the process and encouraged to improve. Moreover, because the present placement process integrates control with a single service provider, the placement service provider, not the employer, determines which applicant-candidates are initially accepted into the placement process. Thus, employers may present offers to candidates who have been previously accepted into the process and have progressed further along in the placement process. Additionally, candidates that drop out of the process are readily replaced with applicant-candidates of the same group type.

The present placement process integrates all placement subparts under the control of one entity which tracks candidates' progress within each of the subparts using a tracking application that executes in the background and may be implemented as a software application loaded on virtually any data processor, firmware on a data processing system, or any other network device capable of executing programming instructions and outputting a result.

For example, the present placement processing and tracking application may reside on a computer, server or similar network element in a distributed data processing system or network of computers. In a distributed data processing system, the medium used to provide communications links between various devices and computers connected together within the distributed data processing system may include permanent connections, such as wire or fiber optic cables, or temporary connections made through telephone connections. The process is accessible by secure sockets on the Internet based on the security level of the requestor. For example, a candidate is typically authorized to view only information for the candidate (e.g., test dates, results (milestone events and time line information). The candidate's employer may be authorized to view information for the candidate and any other candidates accepting employment, comments by the service provider concerning the employer's candidate as well as general information concerning candidates who have not accepted employment offers in the process. Placement service provider administrators will generally have unrestricted access to only the information they need for accomplishing their particular tasks in the placement process.

A server holding the present placement processing and tracking application is connected to the network; clients may also be connected to the network. These clients may be, for example, personal computers, work stations, or network computers which may communicate or otherwise interface with the placement and tracking application being executed on the server, or the application server may instead serve up the application directly to the clients for local execution (in which case the server might be an application server).

In the example, the server connected to the network may be implemented as a symmetric multiprocessor (SMP) system including a plurality of processors connected to a system bus. Alternatively, a single processor system may be employed in the server or client. In either case, the selected processing system may employ a peripheral component interconnect (PCI) local bus architecture or other bus architectures such as Micro Channel and Industry Standard Architecture (ISA) for connecting the processor(s) and main memory to an integrated memory controller and cache memory for the processor(s). Additional connections to the PCI local bus may be made through direct component interconnection, through add-in boards or via bus adapters to other types of bus systems. A bus adapter (e.g., a Small Computer System Interface (SCSI) host bus adapter) may provide a connection for a hard disk drive, tape drive, DVD-ROM drive, CD-ROM drive and/or other memory devices where the placement and tracking application will reside when not being executed. It is expected that during execution all or part of the placement and tracking application will be loaded into the main memory of the server, client or other network device. Additionally, an expansion bus interface provides a connection for a keyboard and mouse adapter for interacting with the placement and tracking application and graphics adapter (e.g., provides a connection for a display screen). As is well known in the art, an operating system runs on the processor and is used to coordinate and provide control of various components within the server or client. The operating system may be a commercially available operating system such as OS/2, which is available from International Business Machines Corporation. “OS/2” is a trademark of International Business Machines Corporation or Windows which is a trademark of and is available from Microsoft Corporation. Instructions for the operating system and applications or programs, including the placement and tracking application, are located on storage devices such as the aforementioned hard disk drive and may be loaded into the main memory for execution by the processor(s).

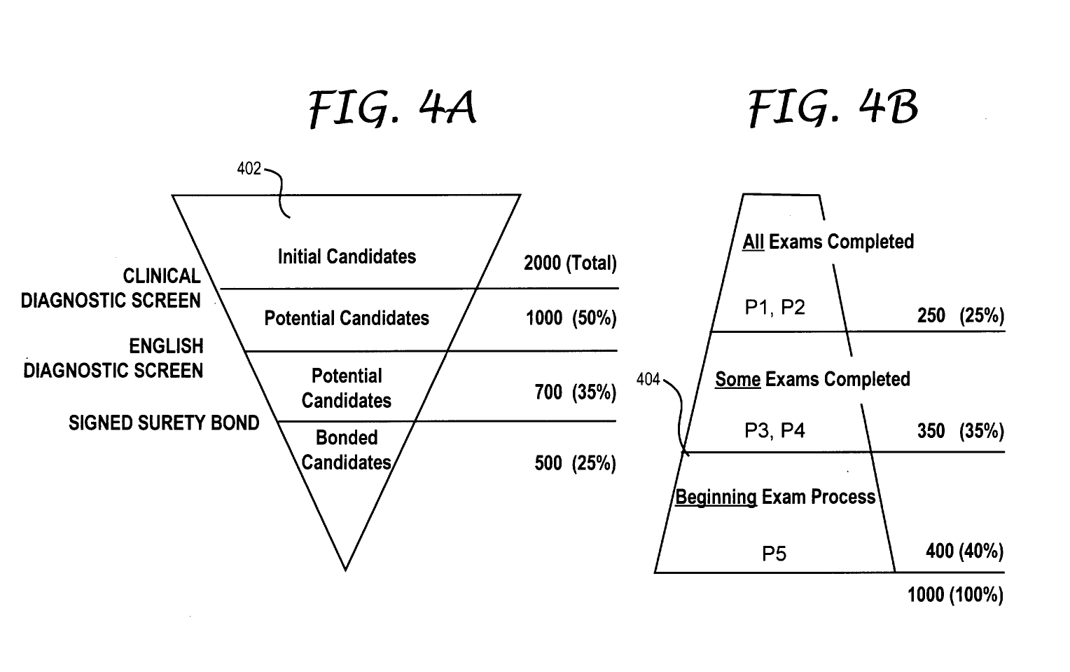

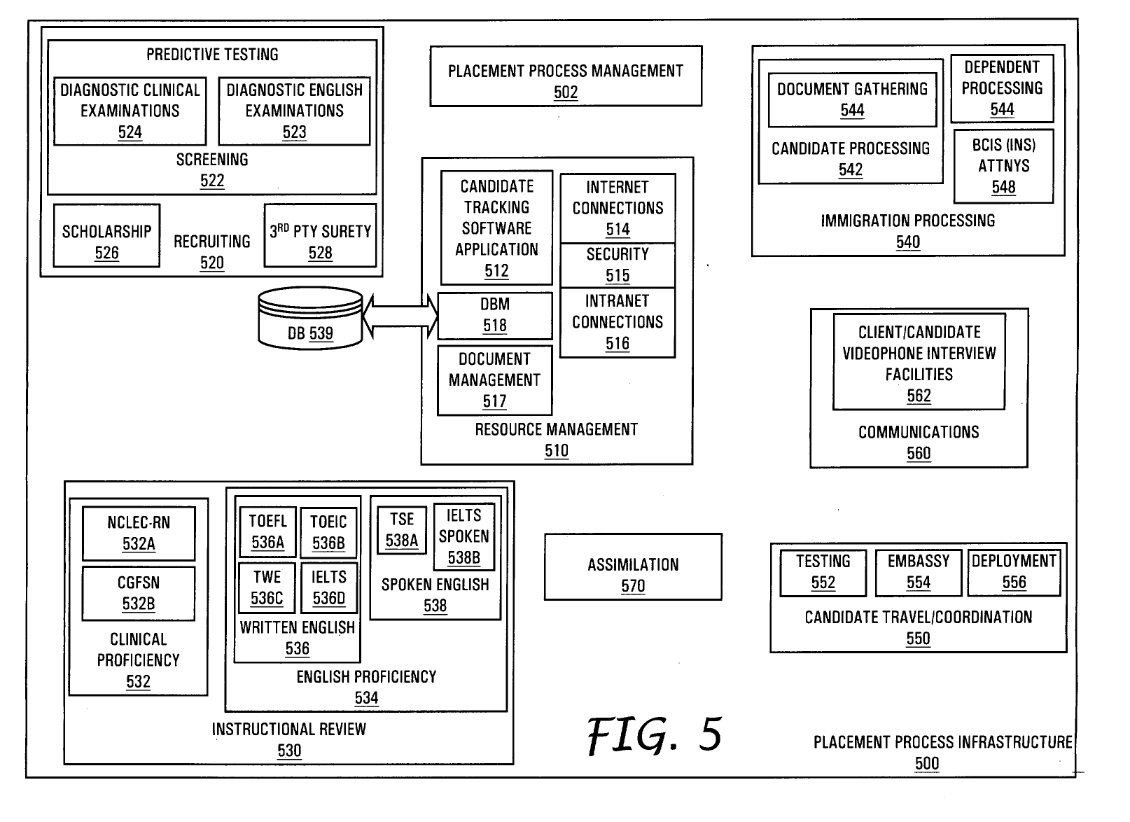

As mentioned above, and in accordance with one exemplary embodiment of the present invention, a pool of candidates participates in varying stages of the exemplary placement process. Turning now to FIGS. 4A and 4B, diagrams of pre-screened candidate group types and candidate group types are depicted which conceptually represent candidate group types as a proportion of the entire pool of screened candidates as may be implemented in accordance with the present invention.

The screening sub-process depicted in FIG. 4A is an attempt to identify successful and therefore profitable candidates, while lessening the financial risk to the placement service provider in accordance with an exemplary embodiment of the present invention. Initially, a pool of “initial candidates” are identified as those who appear to meet the requirements for immigration into the U.S., either licensed nurses or nurse students in an accredited nursing program. The initial candidates may be identified through any of the usual means (e.g., advertising through contact with trade or professional groups, or with the initial candidate making contact with the service provider's representative). In accordance with another exemplary embodiment of the present invention, the service provider may sponsor students currently enrolled in a qualified curriculum by means of scholarships, grants and debt forgiveness to students who intend to enter the placement process after graduation.

In any case, initial candidates are vetting using a clinical diagnostic screening process for ranking initial candidates and assessing the probability of success on the CGFNS and NCLEX-RN examinations. Typically, a high portion of initial candidates are culled at this stage. This group is referred to as the potential candidates, and here vetting continues with English diagnostic screening. The proportion of candidates who are culled at this point is typically somewhat longer than in the clinical diagnostic screening. At this point, the potential candidate is offered a position in the placement process, but is required to obtain a surety bond payable to the service provider.

The surety bond is obtained from a third party surety on behalf of the candidate. The candidate affirms in a contract with the placement service provider that the placement agreement is exclusive to the placement service provider which provides exclusive placement services to the candidate. The candidate also agrees to be placed in the U.S. with an employer to be determined and not to withdraw or drop from the process, or contract with another placement service provider. Furthermore, the placement agreement stipulates that the candidate will use “best efforts” to accomplish each placement sub-process, as well as placement, according to a placement timeline and/or firm date or dates. This provides an objective standard from which the candidate's progress may be compared. Finally, as a condition for being accepted into the placement process, the candidate also agrees to reimburse the placement service provider for costs incurred if the candidate withdraws from the placement process and agrees to reimburse the service provider for lost profits and/or lost opportunities if the candidate contracts with another service provider during some specified time period. The candidate executes a bonding agreement which may be a separate agreement with a service provider and/or the surety. In that agreement, the candidate agrees to indemnify the surety against loss to the placement service provider. The candidate is generally required to pledge specific collateral which is sufficient to secure the bonding amount. Realistically, most candidates do not have sufficient property to pledge, so instead the collateral may be pledged by a friend or relative. Another option is for the candidate to draw, or make a check to either the service provider or the surety (the acceptor) for the amount of the services to be rendered by the placement service provider. This amount may be estimated prospectively or the amount of the check may be left blank unless the candidate breaches the placement service agreement. In either case, if the candidate breaches the placement service agreement the acceptor presents the check to the drawee (the candidate's financial institution) for payment. If the check is honored by the drawee, then all claims by either the placement service provider or the surety are satisfied. If the check is not honored by the drawee, the acceptor may commence a criminal action against the candidate. Any criminal action against the candidate would be uncovered by a subsequent criminal background check on the candidate and bar the candidate from immigrating, especially to the U.S. Thus, a bonded candidate has a good incentive to avoid breaching the placement agreement. More importunately for the placement service provider, the availability of bond lessens the risk of financial losses making the placement service more attractive for lending institutions which may provide bridge loans for processing the candidates prior to placement and receiving payment from the client.

Turning now to FIG. 4B, a diagram representing the type of bonded candidate groups in the placement process are depicted in accordance with an exemplary embodiment of the present invention. As mentioned above, and in accordance with one exemplary embodiment of the present invention, a pool of candidates participates in varying stages of the exemplary placement process. FIG. 4A represents the group types as a proportion of the entire pool of screened candidates as may be implemented in accordance with the present invention. It should be recognized that, in accordance with some exemplary embodiments of the present invention, candidates within any of group types P1 to P5 may be preliminary candidates (i.e., not yet accepted by an employer such as an HCI), whereas in the prior art, all candidates that enter the placement process were accepted by an employer. Furthermore, the present placement process is flexible enough to give a preliminary candidate the latitude to decline an offer, or a number of offers, made by a potential employer and thereby remain a preliminary candidate while remaining in the placement process. The mere fact that preliminary candidates are included in the placement process underscores the differences between the prior art placement process and the present integrated process for placing candidates.

Another feature of the present integrated placement process is that candidates in group types P1 to P5 are not segregated into separate group types based on being a preliminary candidate or an accepted candidate. Instead, candidates in group types P1 to P5 are distinguished from one another based on the placement processing needs of the candidates which populate the groups. Table II below is a tabular listing of group types and the placement processing needs for each candidate within the respective groups and an estimate of the amount necessary to reimburse the service provider should the candidate breach the placement agreement. For example, by comparing FIG. 4B with Table II below, notice that the candidates in group P5 are beginning the examination and therefore must complete all examination requirements, including CGFNS predictor test, NCLEX-RN, TOEFL/TWE/TSE (or equivalents), as well as CGFNS certification. visa screen certification, BCIS, and Embassy processing. Candidates in group P4 have been completed the CGFNS predictive examination for clinical knowledge in the areas of medical, surgical, obstetric, pediatric and psychiatric nursing.

TABLE II

| | Reimbursement | |
|---|---|---|
| Group | Amount | Need |
| P1 | >$5000.00 | BCIS - Embassy |
| P2 | <$5000.00 | BCIS - Embassy - Visa Screen - TOEFL/TWE/TSE |
| P3 | <<$5000.00 | BCIS - Embassy - NCLEX |
| P4 | $500.00 | BCIS - Embassy - Visa Screen - TOEFL/TWE/TSE - NCLEX |
| P5 | $.00 | CGFNS - BCIS - Embassy - Visa Screen - TOEFL/TWE/TSE - |
| | | NCLEX |

It is unreasonable to expect an employer to wait indefinitely for a placement service provider to fill an open position, but on the other hand, any placement process takes a finite period of time to complete. Ordinarily, accepted candidates have shorter placement periods because they have completed various subparts of the prior art placement process from service providers of those subparts. Any placement service provider that provides services for a candidate contingent upon the candidate completing the placement process bears the entire risk of the candidate dropping out of the placement process and/or not being offered a position with an employer. Risk to the service providers includes not only the risk of the candidate dropping out during its subpart, but also the risk of the candidate dropping out of some other subpart of the placement process. In accordance with the present invention, the above-described problems are alleviated by integrating all subparts into a placement process in which only a single service provider assumes the risk for a candidate completing each subpart of the placement process. However, because the risk to the service provider varies depending upon what the candidate needs in the placement process, the proportion of the candidate pool for each group type also varies as depicted in FIG. 4B. Aside from candidate attrition, the candidate pool for each group type is maintained at an optimal proportion of the candidate pool because of the disproportionate need for management resources throughout the process and further because employer demand for candidates is not constant throughout the process. In fact, candidates that have fewer placement processing needs command a high fee from the employer since the employer realizes indirect cost savings based on the abbreviated placement time period. In accordance with one exemplary embodiment of the present invention, tracking candidate progress in the placement process and assessing pool proportions is performed by the tracking application.

Candidate quadrilateral 404 is a logical diagram depicting a pool of candidates in accordance to one exemplary embodiment of the present invention. Quadrilateral 404 depicts candidates being grouped by exemplary type and each group type contributing to a fixed portion of the total candidates in the pool. Notice that the number and proportion of candidates diminishes as the candidates traverse the placement process from the P5 group type at the base of quadrilateral 404 to the P1 group type at the uppermost portion of the quadrilateral. Candidates in groups P1 and P2 represent approximately twenty-five percent of the total members of the candidate pool, while candidates in the P5 group represent approximately 40 percent of the pool. The greatest demand for candidates are for those just entering the placement process. Placement fees to an employer may be reflective of the candidate's group type (i.e., higher fees charged to employers for candidates who are further along in the placement process and therefore capable of being placed with an employer sooner) Demand for candidates may, at least partially, reflect the amount of the placement fees, more demand for entry-level candidates than for other candidates in the placement process who command higher placement fees. Notice from Table II that amount of reimbursement is generally related to the placement fees. Another consideration in determining an optimal proportion of the candidate group types to the candidate pool is attrition. Candidates in the beginning stages of the placement process (i.e., the P5 group) are more likely to drop out of the process than those candidates who are further along in the process. Therefore, the pool of candidates is strategically weighted toward the beginning of the placement process. Candidates in the P1 and P2 groups are the most expensive for employers, but at the same time are highly placeable because they have completed their examinations and placement time is minimal. Therefore, while the combined total of candidates in the P1 and P2 groups is proportionally smaller number than any other group or combinations of groups, it is a significant portion of the total pool.

While the number of candidates in the P1 and P2 groups represent a smaller proportion of the total pool, these candidates are important to the present placement process for another reason; they insure that candidates who drop out of the placement process can be easily replaced with candidates having equivalent placement needs. By maintaining a small number of preliminary candidates (i.e., candidates who have not accepted employment offers) in each of groups P1 through P5, candidates are available for employment offers at each stage in the placement process. An employer that loses a candidate to attrition can interview other candidates who are at approximately the same stage of the placement process. Therefore, a service provider using the present integrated placement process can more readily replace a candidate without pushing back the placement date on the employer. Service providers using the proportioned approach of candidate pool representation can more reliably guarantee a candidate placement date, thereby eliminating the placement risk for the employer, while not substantially increasing the risk for itself. It should be understood that the function of the tracking application is not to maintain the group types at the depicted levels, but instead to accurately track the number of candidates in each group and to provide the service provider with access to the current pool data in real time. Specific candidate proportions may be preset, monitored and adjusted using the placement portion of the placement and tracking application.

As mentioned above, one departure of the present placement process from the prior art is the recognition that each discrete subpart of the placement process need not be performed sequentially but might instead be running simultaneously. Sequential processing, by its nature, infers that the only event that triggers a subsequent sub-process is a sub-process termination event. Essentially, sub-process termination events occur externally to the sub-process that caused the event because the event indicates that the sub-process had ceased execution. Therefore, in order for sub-processes to execute simultaneously, events occurring internally within one subpart may trigger an invocation of an entirely different sub-process. Thus, subparts are dependent upon each other for internally generated triggering events and must communicate with one another via the placement processing and tracking application to achieve the result (i.e., sub-processes must be tightly coupled together).

FIG. 5 is a block diagram depicting placement service provider infrastructure in accordance with an exemplary embodiment of the present invention. Placement infrastructure 500 is a hermetically sealed group of services under the direct control of centralized placement process management 502. It is the function of management 502 to manage, control and arbitrate placement resources and the separate associated placement sub-processes. Aside from management, the placement resources generally come within one of the following categories: resource management 510, recruiting 520, instructional review 530, immigration processing 540, candidate travel 550, communications 560 and candidate assimilation 570. Resource management 510 provides centralized document administration and access through document manager 517 which control access and communication between database manager 518 and database 539. Document manager 517 provides the means for managing and authentication verification for a candidate's source documents such as educational transcripts, certifications, licenses, birth/death certificates, and for identification records such as fingerprint cards and identification photographs, and also for family legal documents such as marriage/divorce/adoption records. Document manager 517 also makes original copy need determinations and provides secure copy and distribution maintenance for those documents. Additionally, document manager 517 provides a centralized postal site for client, candidate and external department correspondence and a secure fax destination and sending site. Properly implemented, document manager 517 manages data ingress and egress to central database 539, thereby decreasing the rate of forged documents, and the incidence of lost/misplaced documents, enhancing confidence of credibility from critical external departments requesting documents, decreasing processing time and cost while increasing the accountability of document processing personnel.

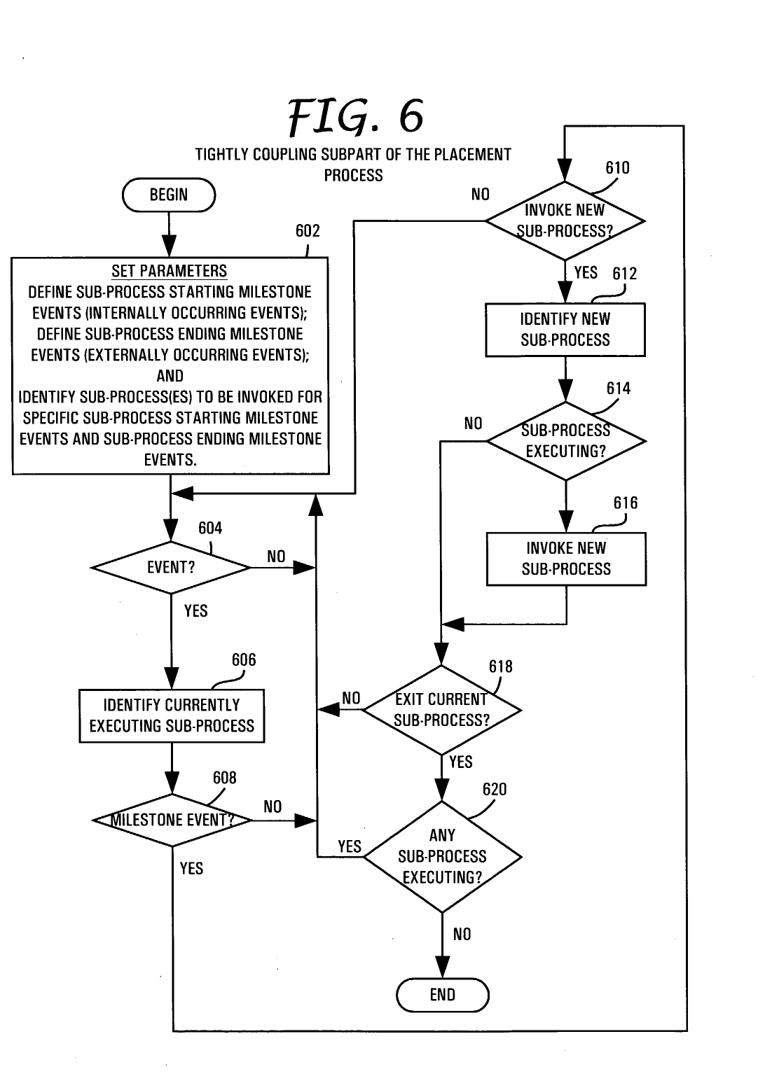

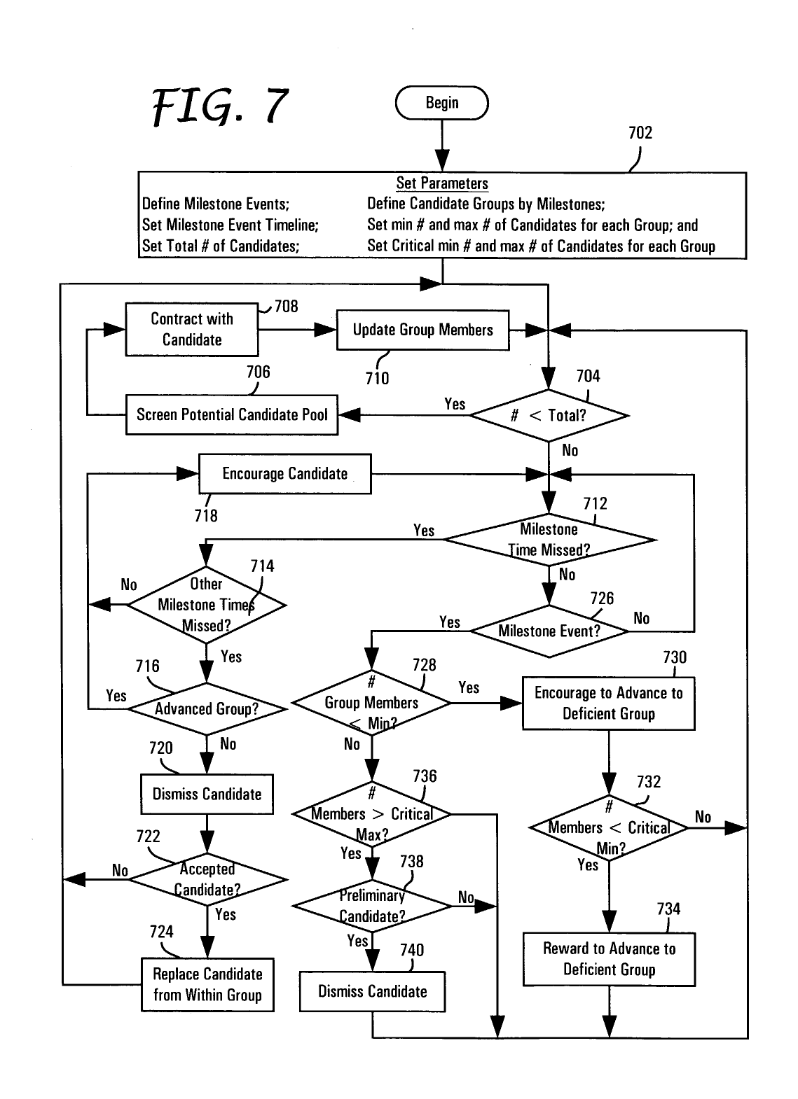

Resource manager 510 control connections to document manager 517 through onsite security 515 which interposes a security layer between any of internet connections 514 and intranet network connections 516 and document manager 517, DBM 518 and candidate tracking software 512. As will be discussed below with regard to FIGS. 6 and 7, candidate tracking software 512 provide the placement infrastructure with centralized examination scheduling and certifications completion criteria. Candidate tracking software 512 utilizes educational reviews and evaluation of candidates current clinical competencies and English proficiency from instructional review hub 530 for formulating and/or modifying the candidate's placement timeline.

Recruiting subpart 520 scrutinizes candidates attempting to enter into the placement process using screen capability 522 for ranking prospective candidates based on their performance on diagnostic clinical examinations 524 for ensuring only candidates with a high probability of exam passage are admitted to the “Full Sponsorship placement Program.” Similarly, diagnostic English examinations 523 ensures only candidates with a high probability of exam passage are admitted to the “Full Sponsorship Program.” Once screened, recruiting subpart 520 secures the candidate's bonding agreement for indemnifying the service provider through third party surety 528. A surety bond ensure recoup of a candidate's direct costs if candidate withdraws and furthermore provides the assurance that candidates which drop from the program will not be included as part of candidate pools of the competition.

Instructional review hub 530 is comprised of the two parts, clinical proficiency part 532 and English proficiency part 534. Instructional staff members are assigned separately to duties in each of these parts, who then provide candidate tracking software 512 with candidate accurate progress data and reliable reviews. Instructional/service staff member are assigned only to specific examination scheduling and certification validation. By maintaining an association between individual staff members and a particular testing and/or external accreditation organization, staffers rapidly become expert sin their narrow instructional discipline. As such, the staff is uniquely positioned for providing educational reviews and timing assessments to management 502, clients of for inputting into candidate tracking software 512. Along with the instructional aspects of their assigned organizations, the individual staff gain a complete understanding of prerequisites for testing, examination request filing, and payments with external organization (CGFNS 532B; NCLEX 532A; TWE 536C; TOEFL 536A; TOEIC 536B, IELTS 536D, TSE 538A and IELTS 538B, as well as Visa Screens, CG-Certification, and National Visa Center (NVC)). These permanent relationships decreased lost paperwork and mistakes in completion of application and/or filing, increase financial controls and lower overall processing time.

In addition to instructional review hub 530, Individual staff dedicated only to specific Exam and Certification processing with external organization associated with document manager 517 (including CGFNS; NCLEX; TWE; TOEFL; TSE; Visa Screen; CG-Certification; National Visa Center (NVC)). As a practical matter the assigned staff members provide centralized document processing for both instructional review hub 530 and document manager 517. this is possible partly because resource manager 510 supports and enables a robust web-based access through secure Internet connections 514.

Additionally, placement architecture 500 also includes specialized immigration processing center 540 devoted to supporting only immigration and BCIS sub-processes. Centralized immigration processing center 540 supports BCIS (Immigration) attorneys 548, who generally are third party contractors paid in flat rate increments, similar to the payment structure between the employer-customer and the placement service provider. Centralized immigration processing center 540 provide proactive document gathering 544 capabilities for expediting BCIS and embassy processing. Using the secure connections of resource manager 510, much of the data gathering for screening, BCIS processing, Packet III embassy requirements etc, can be accomplished on-line. Moreover, dependent processing (spouse, child, etc.) can generally be performed simultaneously with separate dependent BCIS processing means 544. BCIS processing is streamlined by the development of Formal INS Service Center Expedite Letter for each employer-client and by securing a power of attorney for BCIS attorneys 548 to manage candidates filings.

Also included in placement infrastructure 500 is candidate travel/coordination support 550 for testing sites 552, U.S. embassies 554 and deployment at the client-employer's location. Specialized high quality communications 560 may also be incorporated for providing client-employers with a convenient means for interviewing prospective candidates, i.e., client/candidate videophone interview facilities 562.

FIG. 6 is a flowchart depicting a process for tightly coupling subparts of the placement process for implementation in an integrated placement process for acquiring foreign healthcare professionals for domestic service in accordance with an exemplary embodiment of the present invention. The present process begins by identifying or defining milestone events as being one of two types and identifying the specific subsequent sub-process to be invoked based on the occurrence of a particular milestone event (step 602). Milestone events, for the purposes herein, are events which affect some aspect of placement processing. The two major types of milestone events are: sub-process starting milestone events (internally occurring events); and sub-process ending milestone events (externally occurring events). The prior art placement process recognized only sub-process ending milestone events because subparts of the placement process are executed sequentially. Thus, prior art sub-process ending milestone events are all essentially external to the sub-process throwing the event because the that sub-process is ending (e.g., a sub-process termination event). Sub-process starting milestone events, on the other hand, trigger a specific subsequent placement sub-process no matter when the event occurs. By contrast with the prior art, sub-process starting milestone events may be thrown at any time during the execution of a subpart or internal to its execution. Sub-process ending milestone events could also be considered a sub-process starting milestone event; however, for purposes of describing subpart coupling, the two will be considered mutually exclusive.

Dead time within the placement process should is avoided through the use of proactive scheduling routines. Dead time comes about as a result of filing deadlines and turnaround time being out of sync within a sub-process. For example, if a filing deadline falls during the turn-around time for the prerequisite sub-process, then the candidate must wait until the next cycle before filing a request. Other dead time results from the occurrence of certain types of events which toll subsequent filing requests. These types of events should be identified because they stay the execution of a sub-process, thereby delaying its execution and subsequent completion. An example of one such event type is a failure event for certain examinations. When that type of event occurs, it invokes an automatic stay for a predetermined time period before the candidate can re-file and re-take the subject examination. For example, a NCLEX-RN failure event tolls retaking the examination for least 91 days. Another factor which complicates the placement process and leads to dead time in and between sub-processes is the length of turnaround time necessary for a test administrator and/or government agency to respond to the occurrence of an event, such as a testing event or an interview event. Turn-around time for a sub-process event is treated by the present process as dead time associated with an event in which no subsequent sub-processes may be started. In accordance with an exemplary embodiment of the present invention, the length of turnaround dead time is dynamically applied to the time an event occurs for determining a future course of action. If, for example, turnaround time for an event overlaps with the filing deadline for re-filing for the event, the process proactively re-files for the event regardless of whether or not a response has been received for the previous event. With regard to a more specific example, if the turn-around dead time for an examination extends beyond the filing deadline for next examination date cycle, the process proactively files for re-taking the test at the next test date in order not to miss a test cycle. If the candidate passes the examination, then the candidate proceeds to the next sub-process without sitting for the examination. This type of proactive request filing is not possible for subsequent examinations which require submission of the previous examination's score in the filing request.

Once defined, subparts of the placement process are monitored for the occurrence of events (step 604). Upon recognition that an event has occurred, the event and the sub-process that threw the event are identified (step 606). Next, the event is classified as a milestone event or non-milestone event (step 608). It should be understood that, for the purposes of coupling subparts, all milestone events require some type of placement processing action but do not necessarily require that a new sub-process be invoked. Therefore, if the event is determined to be a milestone, then a decision is made whether or not to invoke another sub-process (step 610). If no sub-process need be invoked, then the process reverts to step 604 for checking other events. If the event is determined to be a milestone to invoke another sub-process, then the milestone event must be either a sub-process starting milestone event or a sub-process ending milestone event. The sub-process to be invoked is then identified based on the identity of the event and the sub-process that threw the event (step 612). However, the identified sub-process will be invoked only if it is not being currently executed; therefore, a check is made to determine its status (step 614). If the identified new sub-process is not currently running, it is invoked. If it is currently running, a check is made to determine if the current sub-process (the sub-process that threw the event) should be exited (i.e., if the milestone event is a sub-process ending event (step 618)). If so, the coupling process will end unless other subparts are currently being executed; therefore, it is determined if any sub-process of the placement process is currently executing (step 620). If so, the process reverts to step 604 and continues checking for event occurrences. If not, the process ends.

Coupling subparts of the placement process reduces overall processing time because the subparts are executed in parallel or simultaneously with one another. Therefore, the time required for placing a candidate will be reduced even though the processing time required for completing each discrete subpart might remain essentially unchanged from the prior art. Also, while coupling sub-processes may reduce the overall placement processing time, coupling does nothing to ensure that a particular candidate will be placed within a preset time limit. FIG. 7 is a flowchart depicting an integrated placement process for acquiring foreign healthcare professionals for domestic service within a predetermined time period in accordance with an exemplary embodiment of the present invention.

As mentioned above with regard to the discussion of FIGS. 4A and 4B, one means for ensuring that candidates who drop out of the process can be replaced within the predetermined time limit is to have preliminary candidates available at various stages (group types) of the placement process. Therefore, the process begins by specifying tracking parameters for ensuring compliance with a predetermined time limit (step 702). These parameters include: defining milestone events (events that require some action by the placement process); setting time periods for the occurrence of events and time periods between events; setting the total number of candidates comprising the pool of candidates; defining candidate groups by milestones; setting the minimum and maximum number of candidates for each group; and finally, setting a critical minimum and a critical maximum for the absolute limits of the groups' sizes.

Essentially, the number of candidates in the pool should remain above the predetermined number of candidates parametric value set for the pool, so the pool size is checked (step 704). The predetermined minimum number of candidates specified by the parametric value represents the minimum amount of candidates needed to efficiently process candidates. Anytime the total number of candidates in the pool drops below the predetermined total number parameter, a recruiting sub-process is invoked to bring the number of candidates in the pool above the pre-specified parametric value. The recruiting sub-process includes screening applicant-candidates for admission into the placement processing pool (step 706), contracting with screened candidates (step 708), and finally updating the group members' listing for the newly-admitted preliminary candidates (step 710). Recruiting is an iterative sub-process that is performed recursively whenever the number of pool members drops below the preset total for the pool.

Assuming the pool membership is above the total number necessary for supporting the process, the present placement process involves continually checking for missed milestone times and time limits and checking for the occurrence of milestones. Every candidate must stay on track in order to meet the placement processing time guarantee made to an employer; therefore, milestone times are continually checked for every candidate in the pool (step 712). If a milestone has been missed, the candidate who missed the milestone is further scrutinized. First, the particular candidate's placement processing record is checked for other missed milestone times (step 714). If this is the first missed milestone, the service provider merely encourages the candidate to proceed and possibly provides some advice or remedial class work for weak areas (step 718). Of course, the actual number of missed milestone times tolerated by the service provider may vary based on the candidate, the placement needs of the employer, or on a variety of other factors. At some point, the candidate's continued inclusion in the placement pool must be critically examined. However, it should also be appreciated that more advanced candidates in the placement process (those who have successfully completed more placement subparts (and minor subparts)) may be given more tolerance for missed milestone times. Thus, the candidate's group is identified prior to dismissing the candidate (step 716). If the candidate is in an advanced group, then the candidate might be encouraged to get on track and stay on track in the placement process (step 718).

However, if at step 716 it is determined that the candidate is in a beginning group, or if the candidate is a chronic offender, the candidate is dismissed (step 720). The dismissal of a candidate who has accepted an offer from an employer creates a special problem because the placement processing time commitment to the employer may be negatively impacted. The prior art handled this problem by shifting the risk of placement failure entirely to the employer. Conversely, the present placement processing time guarantee can be supported by replacing the candidate with another candidate who is at an identical point in the placement process. Therefore, a check is made to determine if any candidate leaving the process has accepted an offer from an employer (step 722). If no offer has been accepted (the candidate is a preliminary candidate), the process reverts directly to step 704 to check the pool size and iterate through the recruiting sub-process if necessary. If the candidate is not a preliminary candidate, then that candidate should be replaced by another candidate in the same or more advanced group (step 734) before returning to step 704. However, if a qualified candidate cannot be identified with the departing candidate's group, or if the employer agrees, a less senior candidate could also be selected.

Returning to decision step 712, if a milestone time has not elapsed, the process checks (or waits) for the occurrence of a milestone event (step 726). The occurrence of a milestone event does not necessarily indicate that a candidate has moved out of a group, and even if a candidate has traversed a group, the number of candidates in all groups may be within the specified number for the group. Therefore, the number of group members for one or more groups are checked against the minimum number parameter for the particular group (step 728). Only the groups being affected by a candidate's milestone event need be checked. If the actual number of candidates within a particular group falls below the minimum number parameter for that group, then candidates who are eligible to enter the deficient group are encouraged to complete the requirements (achieve a milestone) for entry into the deficient group (step 730). Next, a check is made to determine if the actual number of candidates within the group has fallen below a predetermined critical minimum number parameter of candidates (step 728). The critical minimum number parameter represents the minimum number of candidates necessary to sustain the present placement process and maintain the placement processing time guarantees to the employers. Should the number of candidates drop below the predetermined critical minimum parameter and remain below the parametric value, then the service provider is at risk for not meeting the placement processing time guarantees made to the employers. Therefore, drastic action may be necessary to encourage candidates to make up the deficiency in the particular group, such as offering rewards to the candidates for completing the requirements for entry into the deficient group (step 734). The placement process then reverts to step 704 for checking the pool size and iterating through the recruiting sub-process if necessary.

Returning to decision step 728, if the number of candidates in the affected groups is greater than the predetermined minimum number parameter for the group, then the affected groups are checked to determine if any of the groups contain more than the predetermined critical maximum number parameter (step 736). The critical maximum number parameter reflects the absolute maximum number of candidates that can be simultaneously processed in a particular group. If the actual number of candidates in a particular group exceeds that critical maximum number parameter, then the number of candidates in the group must be paired down to within the critical number level. However, only preliminary candidates can be dismissed from the group because the dismissal of accepted candidates will jeopardize meeting the placement processing time guarantee for the employer. Therefore, the group is checked for preliminary candidates prior to choosing a candidate for dismissal (step 738). If all candidates in the group have accepted employment offers, the process reverts directly to step 704 and continues. If, however, the number of group members exceeds the predetermined critical amount and preliminary candidates are present in the group, then one or more preliminary candidates are selected for dismissal (step 740) and the process reverts to step 704.

The present placement process continually iterates between checking milestone times and time limits, and checking for milestone events. However, the present placement process is extremely flexible; therefore, parametric placement processing values may be set, reset, adjusted, or optimized on the fly in response to changing conditions. When a parametric value is reset, the present placement method merely iterates through the process using the new value for the parameter.

As mentioned elsewhere above, the placement service provider and not the employer initially screens the applicant-candidates for acceptance into the placement process. Applicant-candidates who do not meet the minimum qualifications for the service providers are not presented to employers for interviews and potential offers of employment. Therefore, in stark contrast with the prior art placement process, the recruiting sub-process is performed simultaneously with the examination subpart. Therefore, the present placement process realizes a reduction in process time equal to the duration of time the prior art expended for recruiting.

Another feature of the present invention is that the present placement process culls weak and unqualified candidates early in the placement process. One particularly effective mechanism for culling weak candidates is with the candidate tracking application which defines candidate milestone events, places time limits for the occurrence of the event, and takes action when milestones are not accomplished within the preset time limit. Another mechanism for culling unqualified candidates in the stages of the process is through the implementation of a rigorous screening process. For example, entry into the United States is dependent upon a number of factors including verifiable documentation of the employee's skill level, demonstrating that the candidate has no criminal background and is of good moral character. Convincing evidence must be submitted to the BCIS prior to granting a visa number to the candidate. Therefore, in accordance with an exemplary embodiment of the present invention, verifiable documentation for character, education, employment and dependent support is required from the candidate during the early minor subparts of the examination sub-process. The candidate will not progress to the later stages of the placement process until the documentation requirement has been met. Likewise, the candidate is pre-screened for a criminal background in the initial stages of the examination sub-process. Candidates with a criminal record are identified early and a decision is reached as to whether or not the candidate should continue. If it is decided that the candidate can continue in the placement process, then the placement service provider has additional time to rehabilitate the candidate's reputation and criminal record prior to BCIS scrutiny.

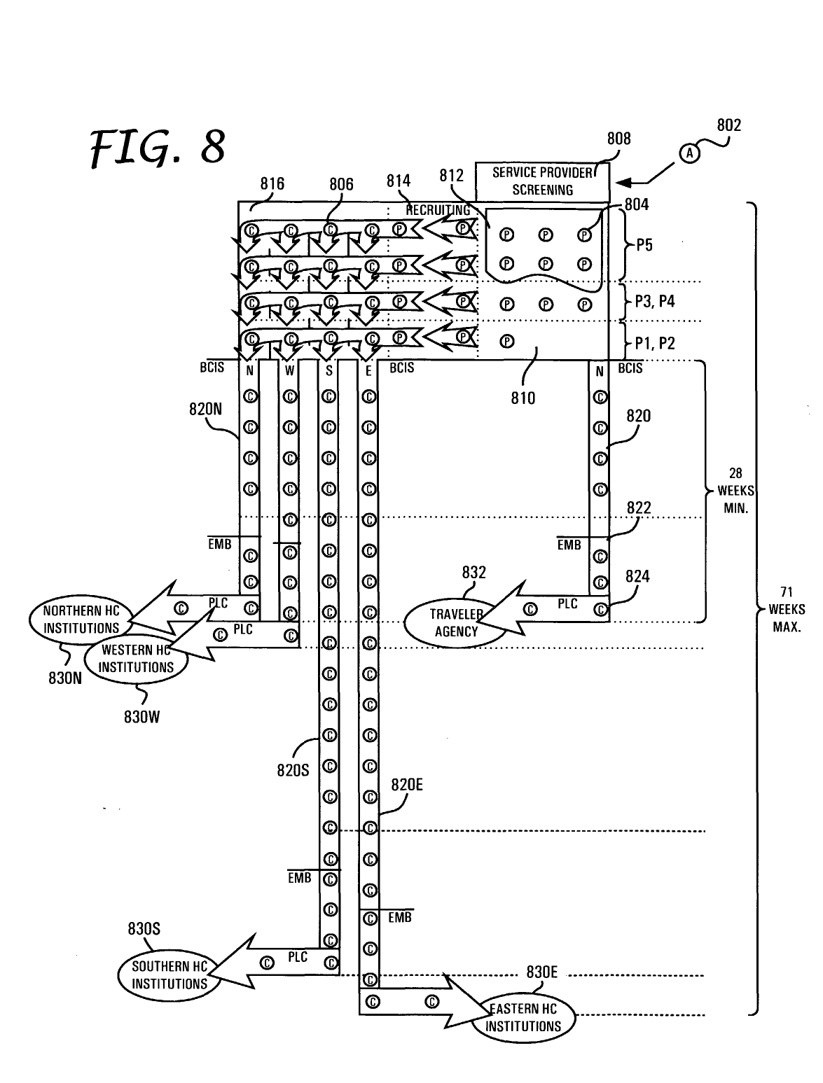

FIG. 8 is a logical diagram illustrating a process for placing foreign professionals in accordance with an exemplary embodiment of the present invention. The vertical dimension elements in the diagram are proportional to the approximate time for completion of the respective processes. The circular-shaped elements represent foreign professionals in the placement process, for instance the “A” element represents application-candidates 802 who have not been accepted into the process by the placement service provider. The “P” elements represent preliminary candidates 804 who have been screened and accepted by the placement service provider. Finally, the “C” elements represent candidates 804 who have been screened by the service provider and have been extended and accepted offers from an employer.

Essentially, applicant-candidate 802 enters the placement process in the upper right hand corner through the placement service provider screening process. Applicant-candidate 802 who met the qualifications set by the service provider is accepted into examination subpart 810 (i.e., preliminary candidates 804). However, preliminary candidates 804 who have merely met the threshold qualifications continue to be scrutinized by the service provider. Here, the aim is to rapidly identify candidates who cannot verify their skill level and employment history, have a criminal background or have a history of moral turpitude. Verifiable documentation is required to be submitted from preliminary candidates 804 within prescribed time periods during examination subpart 810 and criminal background check 812 is performed simultaneously. Criminal background check 812 is a pre-screening carried out by the placement service provider in addition to the criminal background check performed later in the BCIS sub-process by the FBI. Normally, preliminary candidates 840 who are identified as having a criminal background by criminal background check 812 are summarily dismissed from the process. However, if a potential problem is uncovered early in the placement process, it can be dealt with prior to BCIS process; therefore, it may be possible to take steps to repair or rehabilitate the candidate's background prior to the BCIS processing to present the candidate in the best possible light.

Preliminary candidates 804 who have completed criminal background check 812 are available for interviewing and progress to recruiting subpart 814. Notice from the depicted figure that preliminary candidates 804 in any of groups P1-P5 may be recruited by employers. Preliminary candidates in groups P1 and P2, however, have much less time left in the placement process and are available for physical placement with the employer much sooner than are preliminary candidates in other groups. Therefore, candidates in groups P1 and P2 incur far lower indirect costs to the employer and can command a higher fee from the placement service provider.

Once preliminary candidates 804 have received and accepted an offer of employment from an employer, preliminary candidates 804 traverse recruiting subpart 814 and are referred to as a candidate (i.e., candidate 806). Candidates 806 must complete at least a portion of the examination subpart 816 prior to entering BCIS processing 820 because the NCLEX testing portion of the examination subpart is dependent upon the employer's location. Notice also that once candidates 806 have completed recruiting subpart 814, the placement process becomes more geographically focused because both the NCLEX testing and the BCIS processing are dependent upon where candidates 806 will be employed (i.e., the NCLEX testing depends on the particular state where the candidate will be employed and BCIS processing 820 depends on the regional BCIS office that will process the candidate's visa application). However, it should be remembered that regardless of where a candidate is in the placement process, the placement processing and tracking application proactively monitors a candidate's progress by comparing the candidate's progress with a predetermined placement progress timeline.

The present figure graphically illustrates the disparity of the duration of processing time for BCIS offices handling separate regions of the country. For example, candidates 806 accepting offers from northern United States healthcare institutions 830N can expect BCIS process subpart 820N to last approximately twelve weeks for the present placement process. However, by contrast, candidates 806 accepting offers from eastern United States healthcare institutions 830E can expect BCIS process subpart 820E to last approximately 43 weeks. It should be noted that, although the duration of BCIS processing time for the present placement process in not significantly decreased over the prior art, the candidate dropout rate is greatly reduced over the prior placement process because candidates 806 have been pre-screened in criminal background check 812.

The final part of each regional processing leg is embassy processing 822. The duration of embassy processing part 822 is approximately twenty-five percent shorter than the prior art because, in most cases, the overall processing time has been reduced and there is less need for the U.S. consulate to update and verify stale personal information. Moreover, because the present process ensures that a candidate's visa application is complete and fewer RFEs are required by the particular BCIS regional office, fewer candidates require high scrutiny from the U.S. Consulate.

Finally, candidates 806 enter physical placement 824 where they are physically relocated from their home country to the place of employment. Recall that the physical placement and assimilation of foreign employees is a major factor in determining long-term employee retention for foreign employees. And, as a general rule, the tenure of foreign employees is likely to be much longer than that of domestic employees. Therefore, while reducing the duration of physical placement 824 reduces the overall indirect cost to an employer, substantial resources must be allocated by the service provider to ensure that the foreign candidate will properly assimilate into the community.

Returning to examination 810, notice that not all preliminary candidates 804 enter recruiting process 812. Some candidates are hired instead by the placement service provider for traveler nurse employment. Recall for the discussion of candidate quadrilateral 400 in FIG. 4B that the candidates are organized into candidate groups based on the management resources required for the group and not whether the candidates 810 have accepted an employer's offer. Also recall that the placement service provider can charge a higher fee for candidates in group PI because they can be placed sooner and there is a lower risk that the candidate will drop out of the placement process. Therefore, end loading the candidate pool with candidates in groups P1 and P2 may be advantageous for the service provider. However, candidates who languish in examination subpart 810 without entering recruiting process 812 are more likely to become discouraged and drop out of the placement process. Even if the service provider does not end load the pool with group P1 and P2 candidates, it is conceivable that the pool will become end weighted if employers do not extend offers to candidates or the service provider accepts too many applicant entrants into the process. In either case, preliminary candidates 804 who have completed all minor subparts of examination subpart 810 without entering recruiting subpart 814 will become disenchanted with the prospects of employment in the U.S. and drop out of the process. One alternative to the candidate dropping the process is by creating an alternative avenue for the candidate to be placed in the United States. In accordance with an exemplary embodiment of the present invention, candidates who do not enter recruiting subpart 814 may instead be retained in a traveler nurse program offered by the service provider. By offering a second avenue for entry and employment into the United States, transitory imbalances in proportioning candidate quadrilateral 404 and, more importantly, create an incentive for applicant candidates 802 to enter the present placement process without having received an offer from an employer.

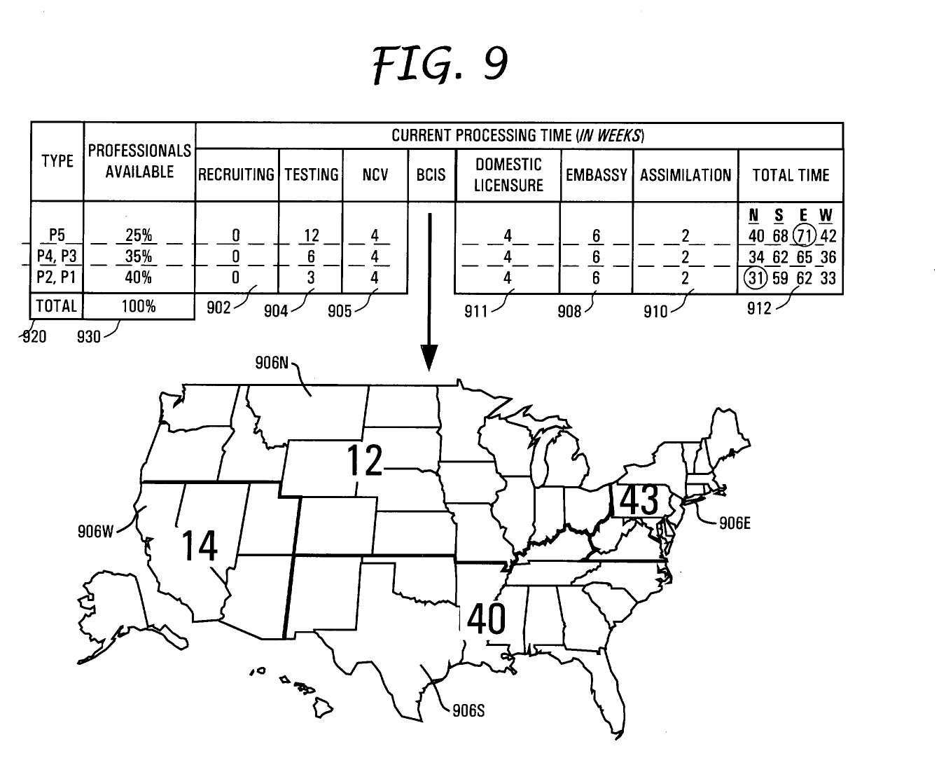

Turning now to FIG. 9, a logical diagram depicting the present placement process for placing nursing professionals is depicted as is the corresponding processing time necessary for completing each placement subpart based on a candidate's group type. FIG. 9 is identical to that depicted in FIG. 2 above for the prior art placement process with the exception of the processing times. Notice that an employer who utilizes a service provider practicing the present placement process will realize a substantial overall decrease in the duration of placement processing time, and consequently reduce indirect costs by a proportional amount.

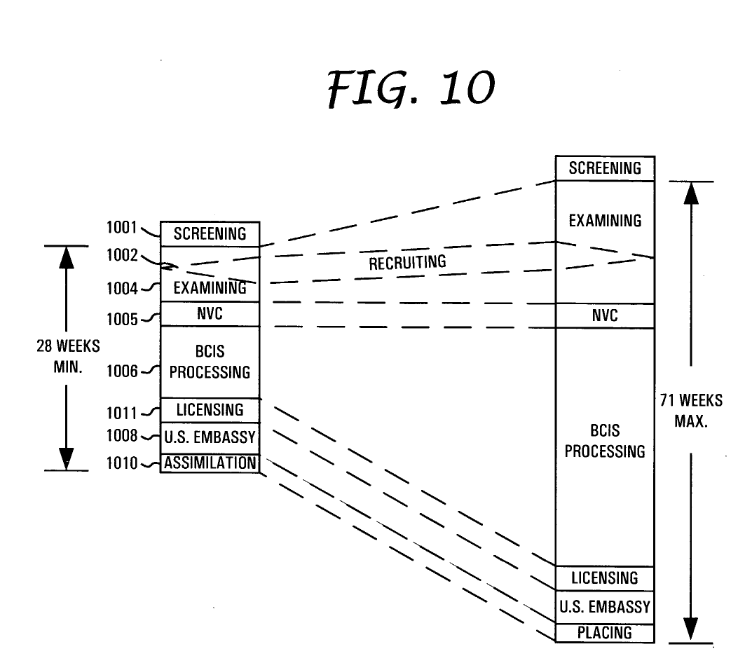

Turning now to FIG. 10, the present placement is represented by a similar diagram to that depicted in FIG. 1 showing the sequence in which the subparts of the placement process are performed in accordance with the present invention. By comparing the diagrams, the benefits of the present placement process are apparent from the reduction in processing time achieved through the present invention. Notice the minimum placement duration is 33 weeks, whereas the minimum time for placing a foreign professional using the prior art process is 38 weeks. Greater benefits are realized with the present invention in processing time savings as placement processing times increase. Notice that the maximum placement duration is 63 weeks for the present placement as compared to 99 weeks with the prior art process for placing foreign professionals.

One source of the benefit realized by the present invention is apparent from the diagram (i.e., recruiting subpart 1002 is no longer a discrete subpart but is now performed simultaneously with examination subpart 1004). Another less apparent source of the benefit is the addition of screening subpart 1001. Screening candidates, as described elsewhere above, has two distinct benefits: 1) sets minimum qualifications for being accepted into the process; and 2) establishes a protocol for culling unqualified candidates early in the placement process, thereby identifying and eliminating unqualified candidates in the early stages. Identifying unqualified candidates early in the placement process, while not lowering total candidate attrition, reduces the total processing time consumed by unqualified candidates and thereby reduces the total processing time for all candidates on a per candidate basis.

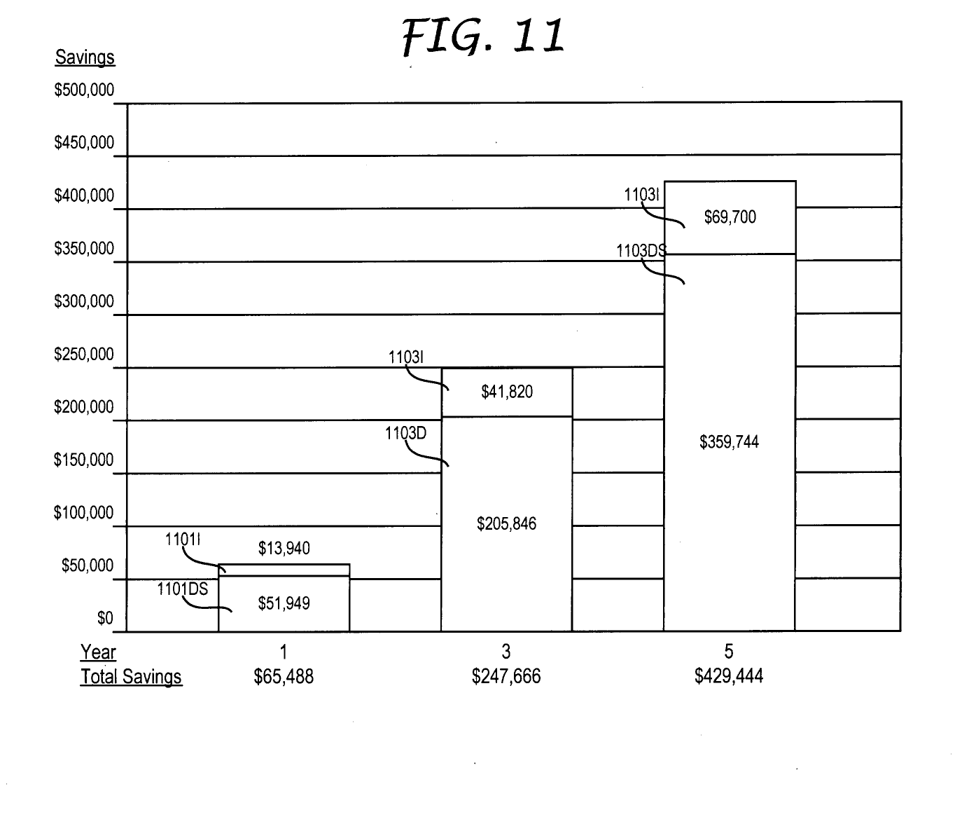

FIG. 11 is a bar chart representing cumulative direct and indirect cost inefficiency to an employer for placing a foreign professional using the prior art. The chart illustrates the indirect costs as they accumulate through three years, years 1, 3 and 5. The total cumulative amount of costs savings over the prior art placement process is represented graphically by the vertical height of a bar and depicted numerically at the base of the bar (i.e., cost savings are $65,488 for year 1, grow to $247,666 for year 3 and reach $429,440 for all five years, year 5). The bar chart further distinguishes each yearly cumulative savings amount as the sum of indirect costs and direct costs associated with the prior art present placement process and the expected savings over the prior art process. In year 1, bar 1101 is comprised of indirect cost savings 1101I associated with the present invention ($13,940) and the direct cost savings 1001D realized $51,949 over the prior art, with more than $65,488 in total savings. Similarly, for year 3, bar 1103 is comprised of indirect cost savings 1103I and $205,846 in direct cost savings 1103D associated with the present invention equaling $247,666 in total savings over the prior art placement process. Remarkably, for the five years depicted in the diagram, the savings realized using the present placement process over the prior art exceeds $429,400.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention and the practical application, and to enable others of ordinary skill in the art to understand the invention for various embodiments with various modifications as are suited to the particular use contemplated.

1. A method for placing a foreign candidate with a domestic employer comprising:
assembling a plurality of foreign candidates in a pool of candidates of a placement process;
processing each foreign candidate in the pool of candidates for employment eligibility requirements;
processing each foreign candidate in the pool of candidates for immigration eligibility requirements;
maintaining a predetermined ratio foreign candidates being processed for one of employment eligibility requirements and immigration eligibility requirements to the plurality of foreign candidates in the pool; and
receiving information indicting a foreign candidate from the pool has been recruited for placement with a domestic employer.

2. The method recited in claim 1 above, wherein assembling a plurality of foreign candidates in a pool of candidates of a placement process further comprises:
screening each of a group of foreign candidates based on employment eligibility requirements;
screening each of a group of foreign candidates based on immigration eligibility requirements;
forming the pool of foreign candidates of the placement process based on one of screening for employment eligibility requirements and screening for immigration eligibility requirements.

3. The method recited in claim 2 above further comprises:
shifting a cost associated with processing candidates for employment eligibility requirements to the employer; and
shifting a cost associated with processing candidates for immigration eligibility requirements to the employer.

4. The method recited in claim 1 above further comprises:
managing the placement process, wherein a single placement service provider manages the placement process.

5. The method recited in claim 3 above further comprises:
managing the placement process, wherein a single placement service provider manages the placement process; and
collecting a placement fee for said foreign candidate recruited from the pool from the domestic employer.

6. The method recited in claim 1 above wherein processing each foreign candidate in the pool of candidates for immigration eligibility requirements further comprises:
identifying a plurality of immigration eligibility requirements;
identifying a plurality of prerequisite immigration eligibility requirements for other immigration eligibility requirements; and
simultaneously processing the plurality prerequisite immigration eligibility requirements.

7. The method recited in claim 1 above wherein the candidate is a foreign nursing professional.

8. The method recited in claim 1 above wherein said employment eligibility requirements further comprise one of National Council Licensure Examination for Registered Nurses (NCLEX-RN) examination and Graduates of Foreign Nursing Schools (CGFNS) examination.

9. The method recited in claim 1 above wherein said employment eligibility requirements further comprise one of a National Council Licensure Examination for Registered Nurses (NCLEX-RN) certification and a Graduates of Foreign Nursing Schools (CGFNS) certificate.

10. The method recited in claim 1 above wherein at least a portion of the plurality of foreign candidates in the pool of candidates have not accepted employment from an employer.

11. The method recited in claim 1 above wherein at least a portion of the plurality of foreign candidates in the pool of candidates have been sponsored by said service provider and placement fees for said at least a portion of the plurality of foreign candidates are waived.

12. The method recited in claim 10 above further comprises:
receiving information indicting said foreign candidate recruited for placement with said domestic employer withdrew from said placement process; and
receiving information indicting a second foreign candidate from the pool has been recruited for placement with the domestic employer, wherein the second foreign candidate is from the at least a portion of the plurality of foreign candidates in the pool of candidates have not accepted employment from an employer.

13. The method recited in claim 1 above further comprises:
receiving information that said foreign candidate recruited for placement with said domestic employer has successfully fulfilled said employment eligibility requirements;
receiving information that said foreign candidate recruited for placement with said domestic employer has successfully fulfilled said immigration eligibility requirements; and
placing said foreign candidate at a domestic location specified by said domestic employer.

14. The method recited in claim 1 above further comprises:
tracking progress of said foreign candidate through a portion of said placement process.

15. The method recited in claim 14 above further comprises:
receiving an indication of an occurrence of an event associated with a sub-part of the placement process, said event being internal to the sub-part of the placement process;
identifying the event;
initiating a second sub-part of the placement process; and
simultaneously tracking the sub-part and the second sub-part of the placement process.
